(19) United States
(12) Patent Application Publication
(10) Pub. No.: US 2006/0063087 A1
(43) Pub. Date: Mar. 23, 2006

(54) Electrostatic latent image developing toner, developer and method of producing the electrostatic latent image developing toner

(75) Inventors: Masanobu Ninomiya, Minamiashigara-shi (JP); Takao Ishiyama, Minamiashigara-shi (JP); Hirokazu Hamano, Minamiashigara-shi (JP); Norihito Fukushima, Minamiashigara-shi (JP); Eiji Kawakami, Minamiashigara-shi (JP); Takashi Fujimoto, Minamiashigara-shi (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/060,812

(22) Filed: Feb. 18, 2005

(30) Foreign Application Priority Data
Sep. 21, 2004 (JP) 2004-274045

(51) Int. Cl. G03G 9/087

(52) U.S. Cl. 430/109.4; 430/111.4; 430/109.1; 430/137.14

(57) ABSTRACT

The present invention provides an electrostatic image developing toner comprising a binder resin, a colorant and a releasing agent, the toner having a temperature interval in which the value of loss elastic modulus varies 100 times or more within a temperature range of 10° C. in the temperature interval between 60 and 95° C. under measuring conditions of an angular frequency of 6.28 rad/sec and a temperature rise rate of 1° C./min, wherein the loss elastic modulus G″ is 5×10³ Pa or more and 5×10⁴ Pa or less and the tangential loss is 1.5 or more and 3.0 or less in a temperature range from 100° C. to 140° C. under a measuring condition of a temperature change rate of 1° C./min.

### CROSS-REFERENCE TO RELATED APPLICATION

This application claims priority under 35 USC 119 from Japanese Patent Application No. 2004-274045, the disclosure of which is incorporated by reference herein.

### BACKGROUND OF THE INVENTION

1. Field of the Invention

The present invention relates to an electrostatic image developing toner which enables the formation of a highly glossy image using reduced energy and is preferably used when forming an image by, for example, an electrophotographic method, to a developer using the developing toner and a method of efficiently producing the electrostatic image developing toner.

2. Description of the Related Art

Conventionally, an electrophotographic method has usually been used when an image can be formed by, for example, a copying machine or a laser beam printer. As the developer used in the electrophotographic method, a two-component system developer comprising toner particles and carrier particles and a one-component system developer comprising magnetic toner particles or non-magnetic toner particles are known. The toner particles in the developer arm usually produced by a kneading and milling method. In this kneading and milling method, a thermoplastic resin or the like is melted and kneaded together with, for example, pits, a charge control agent and a releasing agent such as wax. The melt kneaded product is then pulverized after cooling, after which it is classified producing desired toner particles. Inorganic and/or organic particles are added to the surface of the toner particles produced by the kneading and milling method as needed, for the purpose of, for example, improving fluidity and cleaning characteristics.

In an image arming method using an electrophotographic method, an electrostatic latent image formed on a photoreceptor by an optical means is developed in a developing process, then transferred to a recording medium such as a recording paper in a transfer process and then fixed to the recording medium usually by heating under pressure in a fixing step to obtain an image.

In recent electrophotographic technologies, there has been rapid development from black and white images to full-color images. In color image formation by a full-color electrophotographic method, toners of four colors including three primary a colors, namely, yellow, magenta and cyan and black, are generally used to reproduce all colors. In a general full-color electrophotographic method, first the colors of an original are separated into yellow, magenta, cyan and black to form latent images in each color on a photoconductive layer. These toners are obtained on a recording medium through the subsequent developing and transfer steps. Next, the above processes are carried out plural times one after another wherein each toner is overlapped on the same recording medium while conducting positional alignment. Then, a fixing process is carried out once to obtain a full-color image. As for the color toners used in the full-color electrophotographic method, it is required that these color toners to be sufficiently mixed in the fixing process. If that the color toners are fully mixed, color reproducibility and the transparency of an OHP mage are involved and a high quality full-color image can be obtained. It is generally desirable that the color toners are formed of a sharp-melt low-molecular resin to improve the color miscibility.

Furthermore, there has recently been demand for saving of power consumption and significant improvement in image quality in the electrophotographic method. One measure for saving of power consumption requires fixing an image at lower temperatures to reduce energy consumption during the operation of a machine. Also, a method has been adopted in which power supply to a fixing machine is suspended when not in operation to reduce power consumption during standby time.

When sitting a fixing machine which is in a suspended state, it is required that the fixing machine be immediately raised to working temperature for the sake of convenience when the machine is energized. For this, it is desirable to decrease the heat capacity of the fixing machine as far as possible. In such a case, however, the fluctuation of the temperature of the fixing machine tends to be increased more than usual during normal machine operation. Specifically, the overshoot of the temperature after the machine is energized is increased, while a reduction in temperature due to the passing of paper is also increased. It is therefore desirable to develop toners which are fixed at lower temperatures and are resistant to the generation of image defects in a higher temperature range, namely, toners having a wide fixing latitude.

Further, one requirement for high quality images in electrophotography is for an image to have glossiness equal to or higher than that obtained when using gloss paper provided with a coating layer on the surface thereof. Generally, a high gloss image is obtained by using toners made of a sharp-melt low-molecular resin of a level higher than that required for usual color toners in electrophotography. However, if a very sharp-melt resin is used as the toner, the temperature dependency of the toner is increased, with the resin that the fixing temperature range where a high gloss image can be obtained is narrowed. Moreover, if the glossiness of an image is large, that is, light reflection form the image is large, gloss unevenness in an image surface is noticeable and image defects in the form of gloss unevenness am caused even in the fixing temperature range where no offset arises, thus further narrowing the temperature range where no image defects am caused.

For these reasons, it is very difficult to achieve compatibility between a wide fixing latitude and a high gloss image, and specifically, compatibility between the saving of power consumption and the development of a high quality electrophotographic image.

The use of a crystalline resin has been proposed in an attempt to reduce toner fixing temperature (see, for example, Japanese Patent Publication (JP-B) Nos. 4-24702 and 4-24703 and Japanese Patent Application Laid-Open (JP-A) No. 9-329917). Using these methods, fixing temperature can be reduced simply. However, because the viscosity of the molten toner is too low, image defects such as offset and gloss unevenness are casually caused, effectively giving rise to the problem that a fixing latitude is not obtained.

Further, according to the invention described in JP-A No. 2001-117268, the viscosity of the resin is high and it is therefore difficult to obtain a high gloss image even though a crystalline resin is used and compatibility is achieved between low-temperature fixing and a wide fixing latitude.

At the same time, in recent years there has been increased demand for high quality images. Particularly in the formation of color images, there has been a clear trend toward use of small-sized toners and uniformizing of particle diameter in order to attain highly precise images. If toners having a wide grain distribution are used to form an image, toners on the finer side in a grain distribution are problematic in that they cause significant contamination of developing rolls, charge rolls charge blades, photoreceptors and carriers, as well as toner scattering, which makes it difficult to achieve high image quality and high reliability at the same time. Further, toners having such a wide grain distribution are inferior in reliability even in a system provided with a cleaning function and toner recycle function. It is necessary to sharpen the gain distribution of a toner and to develop a small-sized and uniforms toner in order to achieve high quality and high reliability at the same time.

It is possible to manufacture small-sized and uniform size toners using the aforementioned kneading and milling method. However, this kneading and milling method is a very ineffective production mod due to the prolonged milling process necessary for reduction in size and due to reduced yield caused by the classifying process.

Further, when a toner obtained by internally adding a releasing agent and colorants is produced by the kneading and milling method, the control of the dispersion particle diameter of the releasing agent and colorants depends only on production conditions during kneading and it is therefore not easy to control the dispersion on particle diameter with high precision.

In such circumstances, a method of producing a toner by an emulsion-polymerization-coagulation method has been proposed in recent years as a means of manufacturing a small-sized and particle diameter-uniformed toner (see, for example, JP-A Nos. 63-282752 and 6-250439). The methods proposed in these publications are methods in which a resin particle dispersion solution is prepared by, for example, emulsion polymerization, a colorant dispersion solution in which a colorant is dispersed in an aqueous medium (solvent) is prepared and both solutions are mixed to form coagulated particles having a diameter equivalent to that of the toner, followed by heating to unite the two together, thereby producing a toner.

However, in the case of these methods, it is necessary to prepare a releasing agent dispersion solution or colorant dispersion solution in which a colorant is dispersed in an aqueous solvent. It is, however, difficult to control the average particle diameter of the colorant in the colorant dispersion solution and therefor a toner having desired characteristics cannot be produced with ease. In order to control the average particle diameter of the colorant in the colorant dispersion solution, a colorant dispersion solution is required in which the colorants are not coagulated and sedimented/precipitated but are dispersed with a desired particle size in an aqueous medium (solvent) and the colorants are not mutually coagulated even when the colorants form coagulated particles in combination with resin particles. However, it is not easy to prepare such a colorant dispersion solution. Specifically, when the average particle diameter of the colorant in the colorant dispersion solution is large, this causes various problems such as sedimentation/precipitation of the colorants, mutual coagulation of the colorants with coarse particles forming a core, disengagement of the colorants when the colorants form coagulated particles in combination with resin particles, deterioration in charging characteristics resulting from exposure of the colorants to the surface of the tone and deterioration in OHP light transmittance due to coarse particles. Also, if the average particle diameter of the colorants is small, this gives rise to problems such as insufficient coloring ability of the toner. Inventions relating to the particle diameter/shape of a colorant to be dispersed in a toner have been proposed to solve these problems (sec, for example, JP-A Nos. 2000-242032 and 2003280276). However, none of these inventions goes beyond the improvement of color developing ability/OHP transmittance and there have been no proposals for controlling the loss of elastic modulus of a toner using a colorant.

It is an object of the invention to solve the aforementioned various problems in the prior art and to achieve the following. Accordingly, it is an object of the invention to provide an electrostatic image developing toner which simultaneously satisfies the requirements for (1) low-temperature fixing characteristics, (2) realization of a high gloss image and (3) a wide latitude.

### SUMMARY OF THE INVENTION

According to a first aspect of the present invention, there is provided an electrostatics image developing toner comprising a binder resin, a colorant and a releasing agent, the toner having a temperature interval in which a value of loss elastic modulus varies 100 times or more within a temperature range of 10° C. in a temperature interval between 60 and 95° C. under measuring conditions of an angular frequency of 6.28 rad/sec and a temperature rise rate of 1° C./min, wherein a loss elastic modulus G″ is 5×10³ Pa or more and 5×10⁴ Pa or less and tangential loss is 1.5 or more and 3.0 or less in a temperature mange from 100° C. to 140° C. under a measuring condition of a temperature change rate of 1° C./min.

According to a second aspect of the invention, there is provided an electrostatic image developing developer comprising a toner and a carrier, the toner having a temperature interval in which a value of loss elastic modulus varies 100 times or more within a temperature range of 10° C. in a temperature interval between 60 and 95° C. under measuring conditions of an angular frequency of 6.28 rad/sec and a temperature rise rate of 1° C./min, wherein a loss elastic modulus G″ is 5×10³ Pa or more and 5×10⁴ Pa or less and tangential loss is 1.5 or more and 3.0 or less in a temperature range from 100° C. to 140° C. under a measuring condition of a temperature change rate of 1° C./min.

According to a third aspect of the invention, them is provided a method of producing an electrostatic image developing toner comprising:

producing a resin particle dispersion solution having resin particles having a volume average particle diameter of 1 μm or loss, a colorant dispersion solution and a releasing agent dispersion solution;

mixing the resin particle dispersion solution, the colorant dispersion solution and the releasing agent dispersion solution to prepare a dispersion solution of coagulated particles containing the resin particles, a colorant and a releasing agent; and

uniting the coagulated particles by heating the dispersion solution of coagulated particles to a temperature near or above a melting point of the resin particles to produce a toner having a temperature interval in which a value of loss elastic modulus varies 100 times or more within a temperature range of 10° C. in a temperature interval between 60 and 95° C. under measuring conditions of an angular frequency of 6.28 rad/sec and a temperature rise rate of 1° C./min, wherein a loss elastic modulus G″ is 5×10³ Pa or more and 5×10⁴ Pa or less and tangential loss is 1.5 or more and 3.0 or less in a temperature range from 100° C. to 140° C. under a measuring condition of a temperature change rate of 1° C./min.

### DETAILED DESCRIPTION OF THE INVENTION

It is required for the toner of the present invention to have a temperature interval in which the value of loss elastic modulus varies 100 times or more within a temperature range of 10° C. in the temperature interval between 60 and 95° C. in the measuring conditions of an angular frequency of 6.28 rad/sec and a temperature rise rate of 1° C./min. The presence of the interval in which the value of loss elastic modulus varies 100 times or more within a temperature range of 10° C. in the temperature interval between 60 and 95° C. makes it possible to attain low-temperature fixing. If the interval in which the value of storing elastic modulus and loss elastic modulus varies 100 times or more within a temperature mage of 10° C. exceeds 95° C., the effect of low-temperature fixing is reduced, whereas if the interval is less than 60° C., the problem that toners are coagulated during storage and powder fluidity is therefore reduced arises.

Also, the toner of the invention must have the characteristics that in measuring conditions of an angular frequency of 6.28 rad/sec and a temperature change rate of 1° C./min, the loss elastic modulus G″ is 5×10³ Pa or more and 5×10⁴ Pa or less and the tangential loss is 1.5 or more and 3.0 or less in a temperature range from 100° C. to 140° C.

Generally, the melt viscosity of a toner correlates with the loss elastic modulus of the toner and the loss elastic modulus (melt viscosity) drops along with a rise of temperature. Specifically, the loss elastic modulus (melt viscosity) is very high at the fixable lowest temperature of the toner and drops along with a rise of temperature.

In the case of the invention, there is the temperature interval in which the value of loss elastic modulus (melt viscosity) varies 100 times or more within a temperature range of 10° C. in the temperature interval between 60 and 95° C. and therefore, the fixable lowest temperature of the toner is a temperature just above the temperature at which the loss elastic modulus (melt viscosity) suddenly changes. However, the absolute value of the loss elastic modulus (melt viscosity) of the toner itself is high and is changed largely in a temperature range just above the fixable lowest temperature and therefore, a variation in the gloss of an image obtained by fixing the toner is greatly increased.

When the loss elastic modulus at 100° C. is 5×10⁴ Pa or less like that of the invention, it is possible to obtain high gloss at a temperature as low as 100° C. When the loss elastic modulus (melt viscosity) at 100° C. exceeds 5×10⁴ Pa, high gloss is not obtained at low temperatures and the color reproducibility is deteriorated. It is therefore necessary to raise the fixing temperature to be set and to retard fitting speed, posing problems concerning image qualities/productivity/energy saving with respect to the performance of the machine. When the loss elastic modulus at 140° C. is more than 5×10³ Pa, glass unevenness as well as offset is restrained. On the other band, when the loss elastic modulus at 140° C. is less than 5×10³ Pa, it is difficult to limit gloss unevenness and it is therefore difficult to attain high image quality.

It is necessary to control not only the loss elastic modulus but also the tangential loss to maintain high gloss. If the tangential loss is less than 1.5 even if the loss elastic modulus in a temperature range from 100° C. to 140° C. is 5×10³ Pa or more and 5×10⁴ Pa or less, the storing elastic modulus becomes higher than the loss elastic modulus (melt viscosity) with the result that the elastic repulsion of the toner is high and high gloss cannot be ate. Also, if the tangential loss is higher than 3, the storing elastic modulus is lower than the loss elastic modulus (melt viscosity) and the self cohesive force of the toner is decreased, leading to the generation of gloss unevenness.

Also, in the invention, the loss elastic modulus is designed to be 5×10³ Pa or more and 5×10⁴ Pa or less and the tangential loss is designed to be 1.5 or more and 3.0 or less in a temperature range from 100° C. to 140° C. to thereby decrease a change in viscosity at high temperatures and to make the toner resistant to hot offset and gloss unevenness.

In order to produce a toner having the aforementioned various characteristics according to the invention, a method is considered in which the ratio of the colorant having a volume average particle diameter of 0.1 μm or less in the toner is designed to be 7% by weight or less and 1% by weight or more based on the whole toner. When the colorant having a volume average particle diameter of 0.1 μm or less in the toner is designed to be 7% by weight or less and 1% by weight or more based on the whole toner, the colorant particle component form a network in the toner put in a molten state to exhibit structural viscosity, whereby molten viscosity is maintained and it is therefore possible to reduce a change in the molten viscosity vs temperature.

In order to develop the network forming effect of the colorant in the molten toner efficiently, it is necessary to control the distance between the colorants which distance depends on the particle diameter amount of the colorant. However, as to the concentration of the colorant the colorant is added only in an amount of about 4% by weight to 15% by weight in the toner from the limitation to the color developing ability of the toner. It is therefore difficult to produce the network forming effect of the colorant efficiently in dependence only of the concentration of the colorant. In order to produce the network forming effect of the colorant efficiently, the colorant preferably contains those having a volume average particle diameter of 0.01 μm or more and 0.1 μm or less. When the volume average particle diameter of the colorant is less than 0.01 μm, the size of the colorant is small and therefore the colorants are far apart from each other, leading to difficult formation a network. On the other hand, when the volume average particle diameter of the colorant is larger than 0.1 μm, the surface area of the colorant is decreased, leading to difficult formation of a network.

Also, if the ratio of the colorant having a volume average particle diameter of 0.1 μm or less is less than 1% by weight based on the toner, the amount of particles is small, so that the network forming effect is reduced and therefore, a change in molten viscosity vs temperature cannot be reduced. Also, the ratio of the colorant having a volume average particle diameter of 0.1 μm or less is larger than 7% by weight based on the toner, it is difficult to incorporate the colorant particles into the toner stably, causing the localization of the colorant composition in the toner.

The storing elastic modulus and the loss elastic modulus in the invention are found from the dynamic viscoelasticity measured by a sinusoidal vibration method. The dynamic viscoelasticity is measured by a measuring device (trade name: ARES, manufactured by Reometoric Scientific). The dynamic viscoelasticity is measured as follows: after the toner is formed into a tablet, it is set to a parallel plate 25 mm in diameter. After normal force is set to 0, the plate is vibrated sinusoidally at an oscillation frequency of 6.28 rad/sec. The measurement is started at 50° C. and continued until the temperature becomes 180° C. The interval of measurement time is designed to be 30 seconds and temperature rise rate is designed to be 1° C./min. Also, during measurement, the amount of strain is kept in a range from 0.01% to 1.0% at each measuring temperature and so adjusted appropriately as to obtain fairly measured values to find the loss elastic modulus and the tangential loss from these measured results.

The storing elastic modulus is obtained by dividing the stress in the same phase as the strain by the strain and the loss elastic modulus is obtained by dividing the stress in a phase 90° shifted from the phase of the strain by the strain. As long as the stress and the amount of strain are respectively within a range in which the both are in linear relation with each other (in the invention, the amount of strain is 0.01 to 1.0%), the stress is caused by the strain and the stress is proportional to the magnitude of strain. On that premise, the storing elastic modulus and the loss elastic modulus are both independent on the magnitude of strain. However, in the aforementioned measuring device, there are the upper limit of the stress by the performance of the device itself and the lower limit by sensitivity. When the strain is fixed within the temperature range where the toner of the invent is measured, the device is not sensitive enough to measure because the stress produced in a high-temperature range is small in the case where the strain is small and the stress is beyond the upper limit of the measurable range of the device because the stress generated in a low-temperature range is large in the case where the strain is large. In the case of particularly, the toner of the invention, which is suddenly changed in the elastic modulus and loss elastic modulus, no sum that can be measured in all measuring temperature range is present. Therefore, the device is properly adjusted such that the strain is made smaller in a low temperature range and is increased with a rise in temperature.

The toner of the invention may be produced by blending a resin particle dispersion solution obtained by dispersing resin particles, a colorant dispersion solution and a releasing agent dispersion solution to prepare a dispersion solution of coagulated particles containing resin particles, colorants and a releasing agent by heating and the resulting dispersion solution to a temperature higher than the glass transition temperature of the resin particles to fuse and unite the coagulated particles.

The details of the electrostatic image developing toner of the invention will be clarified through explanations of the production method of the invention.

Resin Particles

Any resin may be used as the binder resin used in the toner of the invention insofar as it satisfies the above requirements. It is, however, preferable to use a crystalline resin as a resin material having the characteristics that the loss elastic modulus is suddenly changed. Here, the term “crystalline” means that in the measurement of differential scanning calorimetry (DSC), not a stepwise endothermic change but a clear endothermic change peak is present and specifically, means that the half width value of the endothermic peak measured at a temperature rise rate of 10° C./min is within 6° C. Among crystalline resins, polyester resins are preferable from the viewpoint of range preserving characteristics after the toner image is formed and particularly from the viewpoint of difficulty in transfer of an image to a resin sheet. Examples of these polyester resins will be explained in the following; however these examples are not intended to be limiting of the invention. The crystalline polyester resins and other polyester resins used in the invention are synthesized from polyvalent carboxylic acid components and polyhydric alcohol components. It is to be noted that in the invention, commercially available products or properly synthesized products may be used as the polyester resin.

Examples of the polyvalent carboxylic acid component include, though not limited to, aliphatic dicarboxylic acids such as oxalic acid, succinic acid, glutaric acid, adipic acid, suberic acid, azelaic acid sebacic acid, 1,9-nonanedicarboxylic acid, 1,10-decanedicarboxylic acid, 1,12-dodceanedicarboxylic acid, 1,14-tetradecanedicarboxylic acid and 1,18-octadecanedicarboxylic acid, aromatic dicarboxylic acids including dibasic acids such as phthalic acid, isophthalic acid, terephthalic acid, naphthalene-2,6-dicarboxylic acid, malonic acid and mesaconic acid, and further, hydrides or lower alkyl esters of these acids

Examples of carboxylic acids having three or more valences include 1,2,4-benzenetricarboxylic acid, 1,2,5-benzenetricarboxylic acid and 1,2,4-naphthalenetricarboxylic acid, and anhydrides or lower alkyl esters of thew acids. These acids may be used either singly or in combinations.

As the acid component, besides the aforementioned aliphatic dicarboxylic acids and aromatic dicarboxylic acids, dicarboxylic acids having a sulfonic acid group are preferably contained. The dicarboxylic acids having a sulfonic acid group are effective in the point of bettering the dispersion of colorant such as pigments. Also, if a sulfonic acid group is contained when whole resins are emulsified or suspended in water to form particles, the resin can be emulsified or suspended without using any surfactant as will be explained later.

Examples of the dicarboxylic acid having a sulfonic acid group include, though not limited to, sodium 2-sulfoterephthalate, sodium 5-sulfoisophthalate and sodium sulfosuccinate. Also, lower alibi esters and acid anhydrides of these salts are also exemplified. These sulfonic acid group-containing carboxylic acid components having two or more valences is contained in an amount of 1 to 15 mol % and preferably 2 to 10 mol % based on the whole carboxylic acid component constituting a polyester. If the content is small, the stability of emulsion particles may be deteriorated with time whereas if the content exceeds 15 mol %, not only the crystallinity of the polyester resin may be deteriorated but also the step of uniting particles after the particles are coagulated is adversely affected, bringing about the disadvantage that it may be difficult to adjust the diameter of the toner.

Moreover, it is preferable to compound a dicarboxylic acid component having a double bond besides the aforementioned aliphatic dicarboxylic acid and aromatic dicarboxylic acid. The dicarboxylic acid having a double bond enables a crosslinking bond formed radically and is therefore preferably used to prevent hot offset during fixing. Examples of such a dicarboxylic acid include, though not limited to, maleic acid, fumaric acid, 3-hexenedioic acid and 3-octenedioic acid. Also, lower alkyl esters or acid anhydrides of these compounds are also exemplified. Among these examples, fumaric acid and malic acid are preferably exemplified in view of cost.

As the polyvalent alcohol component, aliphatic diols are preferable and straight-chain type aliphatic diols having 7 to 20 carbon atoms in its primary chain section are more preferable. If the above aliphatic diol is a branched type, the crystallinity of a polyester resin is reduced and the melting point of the polyester resin is dropped. There is therefore the case where the anti toner-blocking characteristics, image preserving characteristics and low temperature fixing characteristics are deteriorated. Also, when the number of carbons is less than 7, the melting point may be made higher when this aliphatic diol is condensation-polymerized with an aromatic dicaroxylic acid and there is therefore the case where it may be difficult to accomplish low-temperature fixing, whereas when the number of carbons exceeds 20, it may be difficult to obtain a material which can be used practically. From the above reason, the number of carbons is preferably 14 or less.

Specific examples of the aliphatic diol preferably used to synthesize the crystalline polyester used in the invention include, though not limited to, ethylene glycol, 1,3-propanediol, 1,4-butanediol, 1,5-pentanediol, 1,6-hexanediol 1,7-heptanediol, 1,8-octanediol 1,9-nonanediol, 1,10-decanediol, 1,11-undecanediol, 1,12-dodecanediol, 1,13-tridecanediol, 1,14-trtradccanediol, 1,18-octadecanediol and 1,14-eicosanedecanediol. Among these examples, 1,8-octanediol, 1,9-nonanediol and 1,10-decanediol are preferable in consideration of availability.

Examples of the alcohols having three or more valences include glycerin, trimethylol ethane, trimethylol propane and pentaerythritol. These compounds may be used either singly or in combinations of two or more. The content of the aforementioned aliphatic diol component among these polyhydric alcohol components is preferably 80 mol % or more and more preferably 90% or more. When the content of the aforementioned aliphatic diol component is less the 80 mol %, the crystallinity of a polyester resin may be deteriorated and the melting point is dropped and there is therefore the case where anti-toner blocking characteristics, image preserving characteristics and low-temperature fixing ability may be deteriorated. It is to be noted that a monovalent acid such as acetic acid or benzoic acid and a monohydric alcohol such as cyclohexanol or benzyl alcohol may be used or the purpose of adjusting acid value and hydroxyl group value according to the need.

The aforementioned resin is dispersed together with an ionic surfactant, a high-molecular acid and a high-molecular electrolyte such as a high-molecular base in an aqueous medium such as water, heated to a temperature higher than the melting point and treated using a homogenizer capable of applying strong shearing force or a pressure jetting type dispensing machine to form a dispersion solution of resin particles.

The volume average particles diameter of the resin particles is usually 1 μm at the most (1 μm or less) and preferably 0.01 to 1 μm. When the volume average particle diameter exceeds 1 μm, the particle diameter distribution of the electrostatic image developing toners finally obtained may be wide and free particles may be generated, which may tend to bring about reduced performance and reliability. On the other hand, when the volume average particle diameter ills in the above defined range, this is advantageous because the above drawbacks are eliminated, localized toners among toners are reduced, dispersion in each toner is bettered and the dispersion of performance and reliability is reduced. Here the volume average particle diameter may be measured using, for example, a laser diffraction type grain distribution measuring device (for example, LA-700 (trade name), manufactured by Horiba, Ltd.). In the invention, a crystalline resin and an amorphous high-molecular resin may be used together.

When a crystalline resin and an amorphous high-molecular resin are used together, it is preferable to blend the crystalline rein in an amount of 50% by weight or more. Moreover, when a crystalline resin and an amorphous high-molecular resin are used together, it is necessary to increase the ratio of crystalline components in the crystaline resin. The structural ratio of an aliphatic monomer as the crystalline component is preferably 80 mol % or more and more preferably 90 mol % or more. In the case where the crystalline polyester resin is constituted of an aromatic monomer or the like other than aliphatic monomers and the ratio of the structure is low, the molting point of the crystaline polyester resin may be high, with the result that the meting point of the toner finally produced may be raised and it may be therefore difficult to attain low-temperature fixing.

Examples of the amorphous high-molecular resin include conventionally known thermoplastic binder resins. Specific examples of these resins include homopolymers or copolymers of styrenes such as styrene, parachlorostyrene and α-methylstyrene (styrene type resins); homopolymers and copolymers of esters having a vinyl group such as methylacrylate, ethylacrylate, n-propylacrylate, n-butylacrylate, laurylacrylate, 2-ethylhexylacrylate, methylmenthacrylate, ethylmethacrylate, n-propylmethacrylate, laurylmethacrylate and 2-ethylhexylmethacrylate (vinyl type resins); homopolymers and copolymers of vinylnitriles such as acrylonitrile and methacrylonitrile (vinyl type resin); homopolymers and copolymers of vinyl ethers such as vinyl methyl ether and vinyl isobutyl ether (vinyl type resins); homopolymers and copolymers of vinyl ketones such as vinyl methyl ketone, vinyl ethyl ketone and vinyl isopropenyl ketone (vinyl type resins); homopolymers and copolymers of olefins such as ethylene, propylene, butadiene and isoprene (olefin type resins); non-vinyl condensed type resins such as epoxy resins, polyester resins, polyurethane resins, polyamide resins, cellulose resins and polyether resins and graft copolymers of these non-vinyl condensed type resins and vinyl type monomer. These resins may be used either singly or in combinations of two or more.

Among these resins, vinyl type resins and polyester resins are particularly preferable.

In the case of the vinyl type amorphous high-molecular resin, this is advantageous in the point that a resin particle dispersion solution is easily prepared by emulsion polymerization or seed polymerization. Examples of the aforementioned vinyl type monomer include monomers which are the raw materials of vinyl type high-molecular acids or vinyl type high-molecular bases such as acrylic acid, methacrylic acid, maleic acid, cinnamic acid, fumaric acid, vinylsulfonic acid, ethyleneimine, vinylpyridine and vinylamine. In the invention, the aforementioned resin particles preferably contain the above vinyl type monomer as the monomer component. In the invention, among these vinyl type monomers, vinyl type high-molecular acids are more preferable from the viewpoint of easiness in a vinyl type resin formation reaction, and specifically, dissociable vinyl type monomers having a carboxyl group as a dissociable group, such as acrylic acid, methacrylic acid, maleic acid, cinnamic acid and fumaric acid are particularly preferable from the viewpoint of controlling the degree of polymerization and glass transition temperature.

The concentration of the dissociable group in the above dissociable vinyl type monomer is determined, for example, by a method in which particles such as toner particles are dissolved from the surface thereof to measure quantitatively as described in “Chemistry of High-molecular Latex” (Polymer Publisher Meeting). The molecular weights of resins located from the surface to inside of a particle and glass transition point can be determined by, for example this method.

The volume average particle diameter of the aforementioned resin particles is 1 μm at the most (1 μm or less) and preferably 0.01 to 1 μm from the reasons mentioned above.

In the case of the polyester type amorphous high-molecular resin used in combination with the crystalline resin, an amorphous polyester resin is synthesized by dehydration-condensing a polyvalent carboxylic with a polyhydric alcohol.

Examples of the polyvalent carboxylic acid include aromatic carboxylic acids such as terephthalic acid, isophthalic acid, phthalic anhydride, trimellitic anhydride, pyromellitic acid and naphthalene dicarboxylic acid, aliphatic carboxylic acids such as maleic anhydride, fumaric acid, succinic acid, alkenylsuccinic anhydride and adipic acid and alicyclic carboxylic acids such as cyclohexanedicarboxylic acid. One or two or more types of these polyvalent caboxylic acids may be used. Among these polyvalent carboxylic acids, aromatic carboxylic acids are preferably used and carboxylic acids having three or more valences (trimellitic acid or its anhydride) are preferably used in combination with diacarboxylic acids to take a crosslinking structure or branched structure, the securing good fixing characteristics.

Examples of the polyhydric alcohol include aliphatic diols such as ethylene glycol, diethylene glycol, triethylene glycol, propylene glycol butanediol, hexanediol, neopentyl glycol and glycerin, alicyclic diols such as cyclohexanediol, cyclohexanedimethanol and hydrogenated bisphenol A and aromatic diols such as ethylene oxide adducts of bisphenol A and propylene oxide adducts of bisphenol A. One or two or more types of these polyhydric alcohols may be used. Among these polyhydric alcohols, aromatic diols and alicyclic diols are preferable and aromatic diols are more a ble. Polyhydric alcohols having three or more valences (glycerin, trimethylolpropane and pentaerythritol) are preferably used in combination with diols to take a crosslinking structure or branched structure, thereby securing good fixing characteristics.

In this case, a monocarboxylic acid and/or mono-alcohol may added further to the polyester resin obtained by polymerization condensation of a polyvalent carboxylic acid and a polyhydric alcohol to esterify a hydroxyl group and/or carboxyl group at the terminal of the polymer thereby adjusting the acid value of the polyester resin. Examples of the monocarboxylic acid may include acetic acid, acetic anhydride, benzoic acid, trichloroacetic acid, trifluoroacetic acid and propionic anhydride. Examples of the mono-alcohol may include methanol, ethanol, propanol, octanol, 2-ethylhexanol, trifluoroethanol, trichloroethanol, hexafluoroisopropanol and phenol.

The polyester resin may be produced by condensation-reacting the aforementioned polyhydric alcohol with the aforementioned carboxylic acid by a usual method. For example, a reactor equipped with a temperature gauge, a stirrer and a flow-own system condenser is charged with the aforementioned polyhydric alcohol and polyvalent carboxylic acid and as required, a catalyst and the mixture is heated at 150 to 250° C. in the presence of inert gas (nitrogen gas). The by-produced low-molecular compounds are continuously removed out of the reaction system and the reaction is stopped when the reaction solution reaches a presented acid value. The reaction solution is cooled to obtain a target reaction product, whereby the polyester resins can be produced. Given as example of the catalyst used to synthesize this polyester resin are esterifying catalysts including organic metals such as dibutyltin dilaurate and dibutyltin oxide and metal alkoxides such as tetrabutyl titanate. The amount of such a catalyst is preferably 0.01 to 1% by weight based on the total amount of the raw material.

In the case of using a polyester resin as the amorphous polymer, like the case of using the crystalline resin, the polyester resin is dispersed together with an ionic surfactant, a high-molecular acid and a high-molecular electrolyte such as a high-molecular base in an aqueous medium such as water, heated to a temperature higher than the melting point and treated using a homogenizer capable of applying strong shed force or a pressure jetting type dispersing machine, whereby a resin particle dispersion solution can be obtained. The volume average particle diameter of the aforementioned resin particles is 1 μm at the most (1 μm or less) and preferably 0.01 to 1 μm from the reasons mentioned above.

In the case of combining the aforementioned amorphous high-molecular resin with the aforementioned crystalline resin, it is possible to blend plural resins simply to use these resins together or to form a coating layer of the amorphous high-molecular resin on the surface of the crystalline resin. When the surface of the crystalline resin is coated with the amorphous high-molecular resin, the surface condition of the toner can be improved.

Colorant

Any known pigments and dyes may be used as the colorants which are the raw materials of the toner of the invention without any particular limitation. Examples of the pigments include black pigments, yellow pigments, orange pigments, red pigments, blue pigments, violet pigments, green pigments, white pigments and extender pigments.

Examples of the black pigments include Carbon Black, Copper Oxide, Manganese Dioxide, Aniline Black and activated carbon.

Examples of the yellow pigments include Chrome Yellow, Zinc Yellow, Yellow Iron Oxide, Cadmium Yellow, Hansa Yellow, Hansa Yellow 10G, Benzidine Yellow G, Benzidine Yellow GR, Indanthrene Yellow, Quinoline Yellow and Permanent Yellow NCG.

Examples of the orange pigments include Rod Chrome Yellow, Molybdenum Orange, Permanent Orange GTR, Pyrazolone Orange, Vulcan Orange, Benzidine Orange G, Indanthrene Brilliant Orange RK and Indanthrene Brilliant Orange GK.

Examples of the red pigments include Iron Oxide Red, Cadmium Red, Red Lead, Mercury Sulfide, Watchung Red, Permanent Red 4R, Lithol Red, Brilliant Carmine 3B, Brilliant Carmine 6B, Du Pont Oil Red, Pyrazolone Red, Rhodamine B Lake, Lake Red C, Rose Bengale, Eoxine Red and Alizalin Lake.

Examples of the blue pigments include Berlin Blue, Cobalt Blue, Alkali Blue Lake, Victoria Blue Lake, Fast Sky Blue, Indanthrene Blue BC, Aniline Blue, Ultramarine Blue, Charcoil Blue, methylene Blue Chloride, Phthalocyanine Blue, Phthalocyanine Green and Malachite Green Oxalate.

Examples of the violet pigments include Manganese Violet, Fast Violet B and Methyl Violet Lake.

Examples of the green pigments include Chrome Oxide, Chrome Green, Pigment Green, Phthalocyanine Green, Malachite Green Lake and Final Yellow Green G.

Examples of the white pigments include Zinc Oxide, Titanium Oxide, Antimony White and Zinc Sulfide. Examples of the extender pigments include Baryta Powder, Barium Carbonate, Clay, Silica, White Carbon, Talc and Alumina White.

Examples of the dye include various dyes such as basic dyes, acidic dyes, dispersion dyes and direct dyes, for example, an acridine type, xanthene type, azo type, benzoquinone type, azine type, anthraquinone type, dioxazine type, thiazine type, azomethine type, indigo type, thioindigo type, phthalocyanine type, aniline black type, polymethine type, triphenylmethane type, diphenylmethane type, thiazine type, thiazole type and xanthene type and more specifically, Nigrosine, Methylene Blue, Rose Bengale, Quinoline Yellow and Ultramarine Blue.

These colorant may be used either singly or in combinations of two or more, and may be used in a solid solution state. In the case of using these colorants in combinations of two or more, the color of the toner may be arbitrarily controlled by changing the type and mixing ratio of these colorants (pigments).

The colorant is selected in consideration of a hue angle, vividness, brightness, weatherability, OHP transmittance and dispersion characterstics in the toner. The amount of the colorant to be added in the toner is preferably 1 to 20% by weight and particularly preferably 4% to 15% based on the toner particles.

These colorants are dispersed in an aqueous medium by using a known method. At this time, for example, a media system dispersing machine such as a rotating shearing type homogenizer, ball mill, sand mill and attritor or a high pressure counter impact type dispersing machine are preferably used.

These colorants may be coated with polar resin particles by adding the particles which have an acid value of 10 to 50 mg KOH/g and a volume average particle diameter of 100 nm or less in an amount range from 0.4 to 10% and preferably 1.2 to 5.0% prior to use when these colorant are used by dispersing them in an aqueous medium using a polar surfactant.

When the acid value of the polar resin particles is below 10 mg KOH/g, it may be difficult to disperse the colorant particles in the toner whereas when the acid value exceeds 50 mg KOH/g, the dispersion characteristics are improved. However, because the above polar resin itself may form a higher order structure, there is the case where the fixing characteristics of the toner is impaired.

Also, when the amount of the polar resin particles to be added and stuck is below 0.4%, it may be difficult to stick the particles uniformly to the colorant particles though the polar resin particles are stick to the colorant particles. As a result, ft may be difficult to disperse the colorants in the toner in a proper manner. When the amount of the polar resin particles exceeds 10%, the polar resin particles may be coagulated among them excessively and there is a fear that the transparency of OHPs to which the tone is fixed

The polar resin particles may be applied using a known method. Specifically, the colorant particles and ion exchange water are mixed appropriately and then treated using a desired one of the above dispersing machines to produce a colorant particle dispersion solution, to which the polar resin particles are added and stuck. Also, the following method may be adopted. Specifically, the colorant particles and ion exchange water are appropriately blended and then dispersed using an optional one of the aforementioned dispersing machines and then the polar resin particles are added. The mixture is further homogenized to stick the polar resin particles to the colorant particles. Although the polar resin particles may be added either collectively or step by step, they are preferably added dropwise gradually from the viewpoint of adhesion.

The colorant dispersed in the dispersion solution preferably has a volume average particle diameter of 0.03 μm to 0.20 μm wherein the surface of the colorant is preferably coated with a resin.

Also, in order to attain the characteristics of the invention, namely, the characteristics that the loss elastic modulus G″ is 5×10³ Pa or more and 5×10⁴ Pa or less and the tangential loss is 1.0 or more and 3.0 or less in a temperature range from 100° C. to 140° C., the ratio of the colorants having a particle diameter of 0.1 μm or less in the toner is preferably 7% by weight or less and 1% by weight or more based on the toner as mentioned above.

It is preferable to use plural dispersion solutions having different volume average particle diameters to obtain such a colorant dispersion solution. Particularly, in the case of controlling the amount of particles having a size of 0.1 μm or less in the colorant dispersion solution, it is preferable to blend two or more dispersion solutions including a colorant dispersion solution having a volume average particle diameter of 0.1 μm or less and a colorant dispersion solution having a volume average particle diameter of 0.1 μm or more in a desired ratio. Although a dispersion solution can be prepared without any blending operation, it is not easy to control the amount of the colorants having a volume average particle diameter of 0.1 μm or less in the colorant dispersion solution at the same time and precisely, making difficult industrial and stable production.

Releasing Agent (Low Softening Point Material)

Preferable examples of the releasing agent used in the toner of the invention include materials having a primary maximum peak at 60 to 120° C. when measured according to ASTM D3418-8. If the primary maximum peak is less than 60° C., offset may be easily caused during fixing whereas if the primary maximum peak exceeds 120° C., fixing temperature may be raised and the smoothness of the surface of the fixed image may not be obtained, leading to impaired glossiness. In the invention, such a releasing agent is called “low-softening point materials” if necessary. A known measuring device may be used to measure the above primary a maximum peak and for example, DSC-50 manufactured by Shimadzu Corporation may be used. As to, for example, the colon of the aforementioned measurement, the following measuring condition is adopted: the melting points of indium and zinc are used for the calibration of the temperature of the detecting section in the device, the heat of fusion of indium is used for the calibration of caloric, an aluminum pan is used for the sample, an empty pan is used for a control and temperature rise rate is set to 10° C./min.

Examples of the aforementioned releasing agent (low-softening point material) include low-molecular weight polyolefins such as a polyethylene, polypropylene and polybutene; silicones having a softening point by heating; aliphatic amides such as oleic acid amide; erucic acid amide, ricinoleic acid amide and stearic acid amide; vegetable type waxes such as carnauba wax, rice wax, candelilla wax, haze wax and jojoba oil; animal type waxes such as bees wax; mineral petroleum waxes such as montan wax, ozokerite, ceresin, paraffin wax, microcrystalline wax and Fisher-Tropsch wax; and modifications of these waxes. These releasing agents (low-softening point materials) may be used either singly or in combinations of two or more. Among these releasing agents (low-softening point materials), those used in Examples which will be explained later are preferable.

The content of the releasing agent particles in the electrostatic image developing toner is preferably 5 to 30% by weight and more preferably 8 to 25% by weight. If the content is less than 5% by weight only insufficient releasability may be obtained and a so-called offset that the toner is stuck to a fixing roll during high temperature fixing may be easily caused. If the content exceeds 30% by weight the toner may be made so fragile that the toner particles may be easily crushed by stirring in a developing machine, resulting in deteriorated fluidity, durability, charging characteristics and blocking characteristics. Therefore, a content out of the above range is undesirable. The melting point of the above releasing agent is preferably 30° C. or more, more preferably 40° C. or more and particularly preferably 50° C. or more from the viewpoint of the preserving characteristics of the toner.

The volume average particle diameter of the releasing agent particles is usually 1 μm at most (1 μm or less) and preferably 0.01 to μm. When the volume average particle diameter exceeds 1 μm, the particle diameter distribution of the electrostatic image developing toners finally obtained may be wide, fire particles may be generated and the releasing agent may be localized in the toner, which tends to bring about reduced performance and reliability. Here, the volume average particle diameter may be measured using, for example, a laser diffraction type gram distribution measuring device (for example, LA-700 (trade name), manufactured by Horiba Ltd).

In the invention, the releasing agent particles (low-softening point materials) are preferably contained ma dispersed state in the electrostatic image developing toner. Also, the median diameter of the releasing agent particles (low-softening point materials) which diameter is measured by 8 transmission type electron microscope (TEM) is preferably 100 to 2000 nm and more preferably 160 to 1000 nm. When the median diameter is within the above range, this is advantageous in the point that for example, the oilless fixing characteristics, chargeability and image durability can be bettered. On the other hand, when the median diameter is less than 100 nm, the releasing agent is hardly shifted to the surface of the toner and a releasing function is scarcely developed. When the median diameter exceeds 2000 nm, the transparency of OHPs tends to drop.

The above release agent is dispersed together with an ionic surfactant, a high-molecular acid and a high-molecular electrolyte such as a high-molecular base in an aqueous medium such as water, heated to a temperature higher than the melting point and treated using a homogenizer capable of applying strong shearing force or a pressure jetting type dispersing machine, whereby the releasing agent is pod into particles having a size of 1 μm or less.

Other Particles

In the invention, besides the binder resin, the colorants and the releasing agent, other particles may be used. Examples of these other particles include internal additives, charge control agent, inorganic particles, organic particles, lubricant, abrasives and magnetic powder.

Examples of the internal additives include metals and alloys such as ferrites, magnetite, reduced iron, cobalt, nickel and manse and magnetic bodies such as compounds containing these metals.

Examples of the charge control agent include quaternary ammonium salt compounds, Nigrosine type compounds, dyes comprising complexes of, for example, aluminum, iron or chromium and triphenylmethane type pigments. The charge control agent in the invention is preferably made of raw materials which are sparingly soluble in water from the viewpoint of controlling ionic strength which has an influence on stability during coagulating and uniting and reducing pollution of waste water.

Examples of the inorganic bodies include all the particles which are usually used as external additives on the surface of toners such as silica, alumina, titania, calcium carbide, magnesium carbide, tricalcium, phosphate and cerium oxide. Examples of the organic particle bodies include all the particles which are usually used as external additives on the surface of toners such as vinyl type resins, polyester resins and silicone resins. It is to be noted that these inorganic particle bodies and organic particle bodies may be used as fluidity adjuvants, cleaning adjuvants or the like.

Examples of the lubricant include fatty acid amides such as ethylenebisstearic acid amide and oleic acid amide and fatty acid metal salts such as zinc stearate and calcium stearate. Examples of the abrasive material include the aforementioned silica, alumina and cerium oxide.

Examples of the magnetic powder include materials magnetized in a magnetic field and specifically, ferrimagnetic powder of iron, cobalt and nickel, and compounds of ferrites and magnetite. When the magnetic powder is used, it is necessary to pay attention to the transferability of the magnetic body to a water phase and it is preferable to treat the surface of the magnetic body by surface reformations such as hydrophobic treatment.

The volume average particle diameter of these other particles is preferably 0.01 to 1 μm. The volume average particle diameter may be measured using, for example, a laser diffraction type grain distribution measuring device (for example, LA700 (trade name), manufactured by Horiba, Ltd).

<Method of Producing an Electrostatic Image Developing Toner>

The toner of the invention may be produced through a step of preparing a dispersion solution blended with resin particles, a colorant, a releasing agent and the like, a step of preparing a dispersion solution of coagulated particles containing the resin particles, the colorant and the releasing agent and a step of locating the dispersion solution of coagulated particles to fuse and to unite the coagulated particles to a temperature higher than the melting point of the resin particles

Preparation of a Dispersion Solution

Not only the resin particles, colorant particles and releasing agent particles but also other particles may be dispersed in the above dispersion solution. The above dispersion solution may be prepared by properly adding and mixing the resin particles, colorant particle, releasing agent particles and other particles to the dispersing medium or by properly adding and mixing a resin particle dion solution in which the resin particles are dispersed, a colorant particle dispersion solution in which the colorant particles are dispersed, a releasing agent particle dispersion solution in which the releasing agent particles are dispersed and an other particle dispersion solution in which other particles are dispersed.

(Dispersing Medium)

Given as examples of the dispersing medium in the dispersion solution of the aforementioned various particles used in the production of the toner of the invention are aqueous mediums. Examples of the aqueous medium include water such as distilled water and ion exchange water and alcohols. These mediums may be used either singly or in combinations of two or more.

In the invention, it is preferable to add and to mix a surfactant in the above aqueous medium Examples of the surfactant include anionic surfactants such as a sulfate type, sulfonate type, phosphate type and soap type; cationic surfactants such as an amine salt type and quaternary ammonium salt type; and nonionic surfactants such as a polyethylene glycol type, alkylphenolethylene oxide adduct type and polyhydric alcohol type. Among these surfactants, ionic surfactant are preferable and anionic surfactants and cationic surfactants are more preferable.

The above nonionic su ctants are preferably used in combination with the above anionic or cationic surfactants. The above surfactants nay be used either singly or in combinations of two or more.

Specific examples of the above anionic surfactant include fatty acid soaps such as potassium laurate, sodium oleate and sodium ester of castor oil; sulfates such as octyl sulfate, lauryl sulfate, lauryl ether sulfate and nonyl phenyl eth sulfate; sulfonates such as lauryl sulfonate, dodecyl sulfonate, dodecylbenzene sulfonate, sodium alkylnaphthalenesulfonates, e.g., sodium triisopropylnaphthalenesulfonate and sodium dibutylaphthalenesulfonate, naphthalene sulfonate formalin condensate, monooctylsulfosuccinate, dioctyisulfosuccinate, lauric acid amide sulfonate and oleic acid amide sulfonate; phosphates such as lauryl phosphate, isopropyl phosphate and nonyl phenyl ether phosphate; and sulfosuccinates such as sodium dialkylsulfosuccinates, e.g., sodium dioctylsulfosuccinate, disodium lauryl sulfosuccinate and disodium laurylpolyoxyethylene sulfosuccinate.

Specific examples of the cationic surfactant include aminic salts such as laurylamine hydrochloride, stearylamine hydrochloride, oleylamine acetate, stearylamine acetate and stearlyaminopropylamine acetate, and quaternary ammonium salts such as lauryl trimethyl ammonium chloride, dilauryl dimethyl ammonium chloride, distearyl dimethyl ammonium chloride, distearyl dimethyl ammonium chloride, lauryl dihydroxyethyl methyl ammonium chloride, oleyl bispolyoxy ethylene methyl ammonium chloride, lauroyl aminopropyl dimethyl ethyl ammonium ethosulfate, lauroyl aminopropyl dimethyl hydroxyethyl ammonium perchlorate, alkyl benzene trimethyl ammonium chloride and alkyl trimethyl ammonium chloride.

Specific examples of the nonionic surfactant include alkyl ethers such as polyoxyethylene octyl ether, polyoxyethylene lauryl ether, polyoxyethylene stearyl ether and polyoxyethylene oleyl ether; alkyl phenyl ethers such as polyoxyethylene octyl phenyl ether and polyoxyethylene nonyl phenyl ether; alkyl esters such as polyoxyethylene laurate polyoxyethylene stearate and polyoxyethylene oleate; alkyl amines such as polyoxyethylene lauryl aminoether, polyoxyethylene steal aminoether, polyoxyethylene oleyl aminoether, polyoxyethylene soybean aminoether and polyoxyethylene tallow aminoether; alkyl amides such as polyoxyethylene lauric amide, polyoxyethylene stearic aide and polyoxyethylene oleic amide; vegetable oil ethers such as polyoxyethylene castor oil ether and polyoxyethylene rapeseed oil ether; alkanol amides such as lauric acid diethanol amide, stearic acid diethanol amide and oleic acid diethanol amide; and sorbitan ester ethers such as polyoxyethylene sorbitan monolaurate, polyoxyethylene sorbitan monopalmitate, polyoxyethylene sorbitan monostearate and polyoxyethylene sorbitan monooleate. When preparing the dispersion solution in which the resin particles, the colorant, the releasing agent and other resin particles are dispersed, the content of the above resin particles may be 40% by weight or less and preferably about 2 to 20% by weight the content of the above colorant may be 50% by weight or less and preferably about 2 to 40% by weight, the content of the above releasing agent may be 50% by weight or less and preferably about 5 to 40% by weight. Moreover, the content of the above other components (particles) may be increased to the extent that the object of the invention is not impaired, is very small in usual and is specifically 0.01 to 5% by weight and preferably 0.5 to 2% by weight.

As to the above dispersion solution, there is no limitation to a method of preparing it and a method selected properly corresponding to the object may be adopted. Examples of dispersing which may be used include, though not limited to, known dispersing machines such as a Homomixer (Tokushu Kika Kogyo Co, Ltd.), Slusher (Mitsui Mining Co., Ltd), Cabitron ((K.K.) Yurotech), Microfluidizer (Mizuho Kogyo (K.K.)), Manton/Gholin Homogenizer (Gholin), Nanomizer (Nanomizer (K.K.)) and Static Mixer (Noritake Co., Ltd.).

Coagulation Step

In the coagulation step, the dispersion solution of the resin particles, colorant, releasing agent and the like (hereinafter this mixed solution is referred to as “raw dispersion solution” is heated to just below the melting point of the binder resin to coagulate each dispersion piles, thereby forming coagulated particles.

In the formation of the coagulated particles, a coagulating reagent is added to the dispersion solution at ambient temperature under stirring using a rotating shearing type homogenizer to coagulate. As the coagulating agent used in the coagulation step, a surfactant having a polarity opposite to that of the surfactant used as the above dispersing agent or inorganic salt may be used.

Examples of the above inorganic metallic salt include a metalic salts such as calcium chloride, calcium nitrate, barium chloride, magnesium chloride, zinc chloride, aluminum chloride, aluminum sulfate, and the like; and inorganic metallic salt polymers such as poly(aluminum chloride), poly(aluminum hydroxide), calcium polysulfide, and the like. Of these, the aluminum salts and the polymers thereof are particularly suitable. In order to obtain a sharper particle distribution, it is suitable that the inorganic metallic salt is bivalent rather than univalent, trivalent rather than bivalent, and tetravalent rather than trivalent. And, it is preferable the inorganic metallic salt is a polymerization type inorganic metallic salt polymer, if valence number is the same.

Sticking Step

In the sticking step, crystalline and/or amorphous polymer particles as sticking particles are stuck to the spice of the coagulated particles containing crystalline polymer (hereinafter this coagulated particle is referred to as “core particles”) formed through the above coagulation step (hereinafter the core coagulated particles provided with a coating layer on the surface thereof are abbreviated as “stuck resin coagulated particles”). This coating layer corresponds to the surface layer of the toner formed through a uniting step which will be explained later.

The coating layer may be formed by the dispersion solution containing crystalline and/or amorphous polymer particles are further added in the dispersion solution in which core coagulated particles are formed in the coagulation step, wherein other components may be added simultaneously according to the need. When the above sticking particles are stuck uniformly to the core coagulated particles to form a stuck particle layer and the stuck resin coagulated particles a united under heating in the uniting step which will be explained later, the surface of the core coagulated particles is coated with a raw material of the stuck resin coagulated particles (a shell is formed). It is therefore possible to efficiently prevent the releasing agent and the like from being exposed from the toner particles. There is no particular limitation to a method of adding and mixing the sticking particles in the above sticking step. For example, the addition and mixing may be continuously carried out gradually or may be carried out step by step in plural lots. The sticking particles may be added and mixed in this manner, which makes it possible to suppress the generation of particles and to sharpen the grain distribution of the resulting electrostatic image developing toner. Also, the practice of the sticking step enables the incorporation of a lot of colorant dispersion particles used in the invention having a volume average particle diameter of 0.1 μm or less into the toner and is therefore preferable. It is inferred that the sticking particles entrain the colorant dispersed particles 0.1 μm or less in size which are freed in the dispersed mixed solution to incorporate the colorant particles into the surface of the stuck resin coagulated particles. The ratio of the stuck resin coagulated particles is preferably 10% by weight to 40% by weight based on the toner. When the amount of the stuck resin coagulated particles is less than 10% by weight, the amount of the colorant dispersion particles to be incorporated may be reduced, resulting in increased free colorant particles. When the amount of the stuck resin coagulated particles exceeds 40% by weight, on the other hand, the coagulation of the core coagulated particles may arise among them around the center of the stuck resin coagulated particles and there is therefore the case where no shell is formed.

In the invention, the number of the sticking steps to be performed may be one or two or more. In the former case, only one layer of the sticking particles is formed on the surface of the core coagulated particles whereas in the latter case, layers made of added particles are laminated on the core coagulated particles if plural particle dispersions to be added including not only the stuck resin particle dispersion, but also the releasing agent dispersion solution and other material particle dispersions are prepared. In the latter case an electrostatic image developing toner having an complicated and precise hierarchical structure can be obtained and this is advantageous in the point that desired functions can be imparted to the electrostatic image developing toner. In the case of performing the above sticking step plural times and in multistage, the composition and properties of parts from the surface to inside of the electrostatic image developing toner can be changed step by step and the structure of the electrostatic image developing toner can be controlled easily. In this case, it is possible to allow the electrostatic image developing toner to have varied structures and composition gradients from the inside to outside of the toner whereby the properties can be changed. Also, in the uniting step which will be explained later, not only the grain distribution can be maintained and a variation in the grain distribution can be suppressed, but also the addition of the surfactant and stabilizers such as a base or an acid are not necessitated or the amount of these materials can be reduced to the minimum, which is advantageous in the point that the cost can be reduced and the quality can be improved.

For example, if as fist addition particles, the above releasing agent particle dispersion is added to the core coagulated particles and as second addition particles, the sticking particle dispersion solution is added and mixed, a structure like a double shell made of the releasing agent and the resin can be formed in the vicinity of the surface of the resulting toner particles. In this case, wax is made to serve as a releasing agent in an efficient manner during fixing while lining the exposure of the wax.

The condition allowing the above particles to be stuck to the coagulated particles is as follows: Specifically, the temperature is a temperature lower than the melting point of the resin in the core coagulated particles in the coagulation step and preferably the melting point to the melting point −10° C. When these particles are heated at a temperature lower than the melting point of the resin, the core coagulated particles are easily stuck to the sticking particles, with the result that the formed sticking particles tend to be stabilized. The treating time is usually about 5 minutes to 2 hours though it cannot be defined as a whole because it depends on the temperature. During sticking, the dispersion solution containing the core coagulated particles and the addition particle dispersion solution may be allowed to stand stationarily or may be under mildly stirring using a mixer. The latter case is advantageous in the point that uniformly stuck particles tend to be formed.

Uniting Step

In the uniting step, the dispersion solution of coagulated particles or stuck resin coagulated particles containing, for example, the resin particles, the colorant and the releasing agent is heated to a temperature close to and higher the melting point of the resin particles to fuse and to unite the coagulated particles. The fusing step may be cared out at a temperature close to the melting point of the crystalline resin and higher than the glass transition temperature of the amorphous polymer. Also, the shape of the toner can be controlled by the temperature set in the uniting step. If the uniting step is carried out at a temperature higher than the melting point the resin is largely deformed and the toner is therefore made into a sphere because the melt viscosity of the crystalline resin is remarkably dropped. Also, if the uniting step is carried out at a temperature just below the melting point, the resin is deformed gradually and it is possible to make the toner into a potato shape under control because the melt viscosity of the crystalline resin is high.

As to the uniting time, a short time is enough to carry out the uniting step if the above heating temperature is high whereas a long time is required if the above heating temperature is low. Namely, the fusing time is usually 30 minutes to 10 Hrs though it is not defined as a whole because the uniting time depends on the above heating temperature.

In the uniting step, the crosslinking reaction may be run when the binder resin is heated to the melting point or more or when the fusing step is finished. Also, the crosslinking reaction may be carried out at the same time when the uniting step is carried out. In the case of carrying out the crosslinking reaction, an unsaturated sulfonated crystalline polyester resin obtained by copolymerizing double bond components, as the binder resin to allow this resin to enter into a radical reaction, thereby introducing a crosslinking structure. At this time, an initiator as shown below is used

Examples of the initiator include t-butylperoxy-2-ethylhexanoate, cumyl perpivalate, t-butyl peroxylaurate, benzoyl peroxide, lauroyl peroxide, octanoyl peroxide, di-t-butyl peroxide, t-butylcumyl peroxide, dicumyl peroxide, 2,2′-azobisisobutyronitrile, 2,2′-azobis(2-methylbutyronitrile), 2,2′-azobis(2,4-dimethylvaleronitrile), 2,2′-azobis(4-methoxy-2,4-dimethylvaleronitrile), 1,1-bis(t-butylperoxy)3,3,5-trymethylcyclohexane, 1,1-bis(t-butylperoxy)cyclohexane, 1,4-bis(t-butylperoxy)cyclohexane, 2,2-bis(t-butylperoxy)octane, n-butyl-4,4′-bis(t-butylperoxy) valerate, 2,2-bis(t-butylperoxy)butane, 1,3-bis(t-butylperoxyispropyl)benzene, 2,5-dimethyl-2,5-di(t-butylperoxy)hexane, 2,5-dimethyl-2,5-di(t-butylperoxy)hexane, 2,5-dimethyl-2,5-di(benzoylperoxy)hexan; di-t-butyldiperoxyisophthalate, 2,2-bis(4,4-di-t-butylperoxycyclohexyl)propane, di-t-butylperoxy-α-methyl succinate, di-t-butylperoxydimethyl glutarate, di-t-butylperoxyhexahydroterephthalate, di-t-butylperoxycarbonate, 2,5-dimethyl-2,5-di(t-butylperoxy)hexane, diethylene glycol-bis(t-butylperoxycarbonate), di-t-butylperoxytrimethyl adipate, tris(t-butylperoxy)triazine, vinyltris(t-butylperoxy)silane, 2,2′-azobis(2-methylpropionamidinedihydrochloride), 2,2′-azobis[N-(2-carboxyethyl]-2-methyl)propionamidine and 4,4′-azobis(4-cyanovaleric acid). These initiators may be used either singly or in combinations of two or more. The amount and type of the initiator are selected according to the amount of unsaturated positions in the polymer and the type and amount of the colorant which coexists.

The intiator may be mixed in the polymer in advance or may be incorporated into a coagulated block in the coagulation step. Further, the initiator may be introduced in the uniting step or after the uniting step. In the case of introducing the initiator in the coagulation step, sticking step or uniting step or after the uniting step, a solution in which the initiator is dissolved or emulsified is added to a particle dispersion solution (e.g., the resin particle dispersion solution). For example, known crosslinking agent, chain transfer agent and polymerization inhibitor may be added to control the degree of polymerization.

Washing/Drying Step

The united particles obtained in the uniting step are subjected to solid-liquid separation such as filtration, washing and drying to obtain a desired electrostatic image developing toner.

The above solid-liquid separation is preferably carried out by vacuum filtration, pressure filtration or the like in view of productivity though not particularly limited to these methods. As the above washing, it is preferable to thoroughly carry out substitution washing with ion exchange water. In the drying step, an optional method including usual methods such as a vibration type fluid drying method, spray drying method, freeze drying method and flash jet method may be adopted. The water content of the toner particles after drying is adjusted to 1.0% by weight or less and preferably 0.5% by weight or less.

The toner particles granulated through the drying step as mentioned above may use, as other components known additives pros selected according to the object. Examples of these additives include various blown additives such as inorganic particles, organic particles and antistatic control agents.

Examples of the inorganic particles include silica, alumina, titanium oxide, barium titanate, magnesium titrate, calcium titanate, strontium titanate, zinc oxide, quartz sand, clay, mica, silica ash rock diatomaceous earth, cerium chloride, iron oxide red chromium oxide, cerium oxide, antimony trioxide, magnesium oxide, zirconium oxide, silicon carbide and silicon nitride. Among these compounds, silica particles are preferable and particularly, silica particles which are hydrophobically treated are preferable. The above inorganic particles are usually used to improve fluidity. Among the aforementioned inorganic particles, methatitanic acid TiO(OH)₂ can provide a developer which does not adversely affect transparency and has good charging characteristics, environmental stability, fluidity caking resistance, stably and negatively charging characteristics and stable image quality retaining ability. The compound obtained by treating methatitanic acid hydrophobically preferably has a resistance of 10¹⁰ Ω·cm or more because high transferring characteristics can be obtained without generating an inversely polar toner even if a transfer electric field is raised when it is to as color particles and finally as a toner.

Examples of the organic particles include a polystyrene, polymethylmethacrylate and polyvinylidene fluoride. The above organic particles are used to improve cleaning characteristics and transferring characteristics.

The number average particle diameter of the inorganic/organic particles is 80 nm or less and more preferably 50 nm or less. Also, in the case of using an external additive of monodisperse spherical silica or monodisperse spherical organic resin particles, the use of a material having a median diameter of 0.1 μm or more and less than 0.3 μm is preferable to improve and to retain transfer efficiency.

Examples of the charge control agent include salicylic acid metal salts, metal-containing azo compounds, nigrosine and quaternary ammonium salts. The charge control agent is usually used to improve charging characteristics.

In the invention, the external additives am added to and mixed with the color pales. The mixing may be carried out using a known mixer such as a V-type blender, Henshel mixer and Redige mixer. At this time, various additives may be added according to the need. Examples of the additives include other fluidizing agents and cleaning adjuvants or transfer adjuvants such as polystyrene particles, polymethylmethacrylate particles and polyvinylidene fluoride particles.

In the invention, as to the sticking condition of the above inorganic compound to the surface of the color particles, the inorganic compound may be simply stuck to the surface of the color particles mechanically or may be loosely secured to the surface of the color particles. Also, the surface of the color particles may bc coated entirely or partially with the inorganic compound. The amount of the external additive is preferably in a range from 0.3 to 3 parts and more preferably in a range from 0.5 to 2 parts based on 100 parts of the color particles. When the amount to be added is less than 0.3 parts there is the case where the fluidity of the toner is insufficient and also, blocking is insufficiently suppressed by heat storage. When the amount exceeds 3 parts, on the other hand, this brings about an excess coating state and there is therefore the case where excess inorganic oxides are shifted to the neighboring member causing secondary defect. Also, after the both are blended, the mixture may be subjected to a classification process without any problem.

The electrostatic image developing toner of the invention may be preferably produced by the production methods as mentioned above. However, these methods are not intended to be limiting of the invention.

<Electrostatic Image Developing Developer>

The electrostatic image developing toner of the invention is used as a one-component developer or a two-component developer as it is. When the toner is used as the two-component developer, it is mixed with a carrier prior to use.

No particular limitation to the carrier which may be used in the two-component developer and a known cow may be used. The carrier is preferably made to be a resin coat carrier provided with a resin coat layer in which conductive materials are dispersed in a matrix esin on the surface of a core material. This reason is that if the resin coat layer is peeled off, the volume specific resistance is not largely changed and it is possible to exhibit a high quality image for a long period of time.

Examples of the matrix resin may include, though not limited to, a polyethylene, polypropylene, polystyrene, polyacrylonitrile, polyvinyl acetate, polyvinyl alcohol, polyvinylbutyral, polyvinyl chloride, polyvinylcarbazole, polyvinyl ether, polyvinyl ketone, vinyl chloride/vinyl acetate copolymer, styrene/acrylic acid copolymer, straight-silicone resin comprising organosiloxane bonds or its modifications, fluorine resin, polyester, polyurethane, polycarbonate, phenol resin, amino resin, melamine resin benzoguanamine resin, urea resin, amide resin and epoxy resin.

Examples of the aforementioned conductive material may include, though not limited to, metals such as gold, silver and copper, titanium oxide, zinc oxide, barium sulfide, aluminum borate, potassium titanate, tin oxide and carbon black. The content of the conductive material is preferably in a range from 1 to 50 parts and more preferably in a range from 3 to 20 parts based on 100 parts of the matrix resin. Examples of the core material of the carrier include magnetic powder materials which are singly used as the core material and magnetic powder materials obtained by dispersing micronized magnetic powders in a resin. Examples of a method of micronizing magnetic powders and dispersing the micronized powders in a resin include a method in which the resin and the magnetic powders are kneaded and crushed, a method in which the resin and the magnetic powders are spray-dried and a method in which a magnetic powder-containing resin is polymerized in a solution by using a polymerization method. It is preferable to use a magnetic powder dispersion type core material produced by the polymerization method from the viewpoint of high degree of freedom to control the shape of the toner. The carrier preferably contains particle magnetic powders in an amount of 80% or more based on the total weight of the carrier from the viewpoint of making difficult the scattering of the carrier. Examples of the magnetic material (magnetic powder) include magnetic metals such as iron, nickel and cobalt and magnetic oxides such as ferrites and magnetite. The volume average particle diameter of the core material is usually in a range from 10 to 500 μm and preferably in a range from 25 to 80 μm.

Examples of a method of forming the aforementioned resin coating layer on the surface of the core material of the carrier include a dipping method in which the carrier core material is dipped in a coating layer forming solution containing the above matrix resin and conductive material and a solvent, a spraying method in which the coating layer forming solution is sprayed on the surface of the carrier core material, a fluidized bed method in which the coating layer forming solution is sprayed in the state that the carrier core material is floated by a fluid air and a kneader coater method in which the carrier core material and the coating layer forming solution are mixed in a kneader coater, followed by removing a solvent.

Any solvent may be used as the solvent used in the aforementioned coating layer forming solution insofar as it dissolves the above matrix resin. For example, aromatic hydrocarbons such as toluene and xylene, ketones such as acetone and methyl ethyl ketone, ethers such as tetrahydrofuran and dioxane may be used. Although the aver film thickness of the resin coating layer is usually in a range from 0.1 to 10 μm, it is preferably in a range from 0.5 to 3 μm to exhibit stable volume specific resistance with time.

The volume specific resistance of the carrier used in the invention is preferably in a range from 10⁶ to 10¹⁴ Ω·cm and more preferably in a range from 10⁸ to 10¹³ Ω·cm at 1000 V corresponding to the upper or lower limit of usual developing contrast potential. When the volume specific resistance is less than 10⁶ Ω·cm the reproducibility of fine lines may be deteriorated and the injection of charges may tend to cause toner fogging on the background portion. On the other hand, when the volume specific resistance exceeds 10¹⁴ Ω·cm, a black solid and a halftone may not be reproduced exactly. Also, the amount of the carrier shifted to a photoreceptor may be increased, which may tend to damage the photoreceptor.

As the electrostatic latent image developer of the invention, the aforementioned electrostatic latent image developing toner of the invention is preferably mixed and adjusted to a range from 3 to 11 parts based on 100 parts of the carrier.

### EXAMPLES

The present invention will be explained in more detail by way of examples. However, these examples should not be construed as limiting the scope of the invention.

(Method of Measuring Grain Size)

The size in the invention will be explained. When particles measured in the invention is 2 μm or more in size, Coulter Counter TA-II type (manufactured by Beckman Coulter) is used as a measuring device and ISOTON-II (manufactured by Beckman Coulter) is used as an electrolyte.

As to a measuring method, 0.5 to 50 mg of a sample to be measured is added in 2 ml of an aqueous 5% solution of a surfactant, preferably sodium alkylbenzenesulfonate, as a dispersant. The resulting solution is added to 100 ml of the electrolyte.

The electrolyte in which the sample is tended is dispersed using a ultrasonic dispersing machine or one minute and then subjected to the aforementioned Coulter Counter TA-II type using an aperture having an aperture diameter of 100 μm to measure the grain distribution of particles 2 to 60 μm in size, thereby finding the volume average distribution and a number average distribution, wherein the number of particles to be measured is 50000.

The grain size of the toner in the invention is found by the following method. In the measured gram distribution, volume accumulated distributions in divided ranges (channel) of grain size are depicted from a smaller grain size side to define the volume average particle diameter at which the accumulation of the distribution is 50%, as D50.

Also, when the size of the particle measured in the invention is less than 2 μm, the grain size is measure by a laser diffraction type grain distribution measuring device (trade name: LA700, manufactured by Horiba Ltd.). As to a measuring method, the amount of the sample put in the dispersion solution is adjusted to about 2 g as a solid content. To this dispersion solution is added ion exchange water to be a volume of about 40 ml. This solution is poured into a cell until the concentration becomes a desired value and then allowed to stand for about 2 minutes to measure the grain size of the toner when the concentration in the cell is almost stable. The obtained volume average particle diameters in each channel are accumulated from a smaller volume particle diameter side. A volume avenge particle diameter at which the accumulation is 50% is defined as the volume average particle diameter.

In the case of measuring powders such as external additives, 2 g of a measuring sample is added in 50 ml of an aqueous 5% solution of a surfactant and preferably sodium alkylbenzenesulfonate, followed by dispersing for 2 minutes using a ultrasonic dispersing machine (1000 Hz) to prepare a sample which is measuring in the same manner as in the ase of the aforementioned dispersion solution.

(Method of Measuring the Shape Factor SF1 of the Toner)

The shape actor SF1 of the toner is obtained in the following manner: an optical microscopic image of toners spread on a slide glass is take in a Luzex image analyzer though a video camera to calculate the square of the maximum length of 50 toners/projected area (ML²/A) and then to find an average.

(Method of the Molecular Weight and Molecular Weight Distribution of the Toner and Resin Particles)

With regard to the electrostatic image developing toner of the invention, the specific distribution of molecular weight is that measure in the following condition. In GPC, a device (trade name: HLC-8120GPC, SC-8020, manufactured) is used, two columns (trade name: TSKgel, SuperHM-H, manufactured by Tosoh Corporation, 6.0 mm ID×15 cm) are used and THF (tetrahydrofuran) is used as an eluent. Experimental condition is as follows: concentration of the sample: 0.5%, flow rate: 0.6 ml/min, amount of sample to be injected: 10 μl, measuring temperature: 40° C., using an IR detector to carry out experiment. Also, the calibration curve is made using 10 samples (“Polystyrene standard sample TSK standard”: “A-500”, “F-1”, “F-10”, “F-80”, “F-380”, “A-2500”, “F-4”, “F-40”, “F-128” and “F-700”.

(Method of Measuring the Melting Point of the Releasing Agent and the Glass Transition Temperature of the Toner)

The melting point of the releasing agent used in the toner of the invention and the glass transition temperature of the toner are found from the primary maximum peak measured according to ASTMD 3418-8.

The primary maximum peak may be measured using DSC-7 manufactured by Parkin Elmer. For the temperature calibration of the detective portion of this advice, each melting point of indium and zinc is used. The eat of fusion of indium is used for the calibration of calorie, an aluminum pan is used for the sample, an empty pan is used for a control and temperature rise rate is set to 10° C./min.

Preparation of a Crystalline Polyester Resin Dispersion Solution (1)

A three-neck flask is charged with 56.5 mol % of dimethyl sebacate, 30.5 mol % of 1,10-dodecanic diacid, 13.0 mol % of 5-t-butylisophthalic acid, ethylene glycol (1 mol equivalent to the acid component), 1,4-butanediol (1 mol equivalent to the acid component) and Ti(OBu), (0.012% by weight to the acid component) as a catalyst. A condensation reaction of the mixture is run at 190° C. under reduced pressure in an inert gas atmosphere. During the reaction, the polymer is sampled. When the molecular weight Mw (weight average molecular weight) is 28500 in GPC, the reaction is stopped to obtain a crystalline polyester resin (1).

Next, a stainless beaker is charged with 80 parts of this crystalline polyester resin (1) and 720 parts of deionized water and is then placed in a hot bath which is then heated to 95° C. When the crystalline polyester resin is melted, the mix is stirred at 8000 rpm by using a homogenizer (trade name: Ultraturrax-150, manufactured by IKA). Then, the mixture is emulsified and dispersed with adding dropwise 20 parts of an aqueous solution in which 1.0 part of an anionic surfactant (trade mark: Neogen RK, manufactured by Dai-ichi Kogyo Sciyaku Co., Ltd.) is diluted, to prepare a crystalline polyester resin dispersion solution (1) having an average particle diameter of 0.18 μm. Also, the amount of water is adjusted such that the concentration of resin particles is 10% by weight

Preparation of a Crystalline Polyester Resin Dispersion Solution (2)

A three-neck flask is charged with 60 mol % of sebacic acid, 40 mol % of 1,10-dodecanic diacid, 3.5 mol % of sodium isophthalic acid dimethyl-5-sulfonate, 1,6-hexanediol (2 mol equivalent to the acid component) and Ti(OBu)₄ (0.02% by weight to the acid component) as a catalyst. A condensation reaction of the mixture is run at 220° C. under reduced pressure in an inert gas atmosphere.

During the n, the polymer is sampled. When the molecular weight Mw (weight average molecular weight) is 20500 in GPC, the reaction is stopped to obtain a crystalline polyester resin (2).

Next, a stainless beaker is charged with 80 parts of this crystalline polyester resin (2) and 720 parts of deionized water and is then placed in a hot bath which is the heated to 95° C. When the crystalline pour resin is melted, the mixture is stirred at 8000 rpm by using a homogenizer (trade name: Ultraturrax T50, manufactured by IKA). Then, the mixture is emulsified and dispersed with adding dropwise 20 parts of an aqueous solution in which 1.0 part of an anionic surfactant (trade mark: Neogen RK manufactured by Dai-ichi Kogyo Seiyaku Co., Ltd.) is diluted, to prepare a crystalline polyester resin dispersion solution (2) having an average particle diameter of 0.25 μm. Also, the amount of water is adjusted such that the concentration of resin particles is 10% by weight.

Preparation of a Crystalline Polyester Resin Dispersion Solution (3)

A three-neck flask is charged with 85 mol % of dimethyl sebacate, 15 mol % of n-octadecenylsuccinic acid anhydride, ethylene glycol (1.5 mol equivalent to the acid component) and Ti(OBu)₄ (0.012% by weight to the aced component) as a catalyst. A condensation reaction of the mixture is run at 170° C. under reduced pressure in an inert gas atmosphere. During the reaction, the polymer is sampled. When the molecular weight Mw (weight average molecular weight) is 35000 in GPC, the reaction is stopped to obtain a crystalline polyester resin (3). Next a stainless beaker is charged with 80 parts of this crystalline polyester resin (3) and 720 parts of deionized water and is then placed in a hot bath which is then heated to 95° C. When the crystalline polyester resin is melted, the mixture is stirred at 5000 rpm by using a homogenizer (trade name: Ultraturrax T50, manufactured by IKA). Then, the mixture is emulsified and dispersed with adding dropwise 20 parts of an aqueous solution in which 1.6 parts of an anionic surfactant (trade mark: Neogen RK, manufactured by Dai-ichi Kogyo Seiyaku Co., Ltd.) is diluted, to prepare a crystalline polyester resin dispersion solution (3) having a volume average particle diameter of 0.28 μm. Also, the amount of water is adjusted such that the concentration of resin particles is 10% by weight.

Preparation of a Crystalline Polyester Resin Dispersion Solution (4)

A three-neck flask is charged with 20 mol % of sodium isophthalic acid dimethyl-5-sulfonate, 75 mol % of 5-t-butylisophthalic acid, 1,6-hexanediol (1.5 mol equivalent to the acid component) and (n-Bu)₂SnO (0.04% by weight to the acid component) as a catalyst A condensation reaction of the mixture is run at 230° C. under reduced pressure in an inert gas atmosphere. During the reaction, the poor is sampled. When the molecular weight Mw (weight average molecular weight) is 13000 in GPC, the reaction is stopped to obtain a crystalline polyester resin (4). Next, a stainless beaker is charged with 80 parts of this crystalline polyester resin (4) and 720 parts of deionized water and is then placed in a hot bath which is heated to 95° C. When the crystalline polyester resin is melted, the mixture is stirred at 8000 rpm by using a homogenizer (trade name: Ultraturrax T50, manufactured by IKA). Then, the mixture is emulsified and dispersed with adding dropwise 20 parts of an aqueous solution in which 1.6 parts of an anionic surfactant (trade mark: Neogen RK, manufactured by Dai-ichi Kogyo Seiyaku Co., Ltd.) is diluted, to prepare a crystalline polyester resin dispersion solution (4) having a volume average particle diameter of 0.19 μm. Also, the amount of water is adjusted such that the concentration of resin particles is 10% by weight.

Preparation of an Amorphous Polymer Dispersion Solution

Styrene: 290 parts

n-butylacrylate: 110 parts

Acrylic acid: 8 parts

Dodecanethiol): 8 parts

Octanedioldiacrylate: 2 parts

The above components are mixed and dissolved. The mixture is dispersed and emulsified in a solution prepared by dissolving 6 parts of a nonionic surfactant (trade name: Nonipol 400, manufactured by Sanyo Chemical Industrial Ltd.) and 10 parts of an anionic surfactant (trade name: Neogen SC, manufactured by Dai-ich Kogyo Seiyaku Co., Ltd.) in 560 parts of ion exchange water in a flask 50 parts of ion exchange water in which 4 part of ammonium persulfate is dissolved is poured into the resulting mixture. After the atmosphere in the flask is replaced with nitrogen, the mixture in the flask is heated to 70° C. in an oil bath with stirring and emulsion-polymerization is continued as it is for 5 hours. Thus, an amorphous polymer dispersion solution in which resin particles having a volume average particle diameter of 180 nm, a glass transition point of 53° C. and a weight average molecular weight (Mw) of 30,000 are is prepared. Also, the content of water is adjusted such that the concentration of particles is 10% by weight.

Preparation of a Releasing Agent Dispersion Solution

Paraffin wax (trade name: HNP9, manufactured by Nippon Seiro Co., Ltd, melting point: 77° C.): 60 parts

Anionic surfactant (trade name: Neogen RK, manufactured by Dai-ich Kogyo Seiyaku Co., Ltd.): 4 parts

Ion exchange water: 200 parts

The above components are heated to 120° C. and disk using a homogenizer (trade name: Ultraturrax: T50, manufactured by IKA), followed by dispersion treatment using a Manton/Gholin Homogenizer (manufactured by Gholin), to prepare a releasing agent dispersion solution in which a releasing agent having an average particle diameter of 250 nm is disposed. Also, the content of water is adjusted such that the concentration of particles is 10% by weight.

Preparation of Colorant Particle Coating Polar Resin Particles

Acrylic acid; 6 parts

Ethylacrylate: 70 parts

Styrene: 24 parts

The above components are mixed and dissolved. In the meantime, a solution prepared by dissolving 6 parts of a nonionic surfactant (trade name: Nonipol 400, manufactured by Kao Corporation) and 10 parts of an anionic surfactant (trade name: Neogen SC, marred by Dai-ich Kogyo Seiyaku Co. Ltd) in 550 parts of ion exchange water is placed in a flask to which the above mixed solution is added, followed by dispersing and emulsifying. 50 parts of ion exchange water in which 1 part of ammonium persulfate is dissolved is poured into the above emulsion with slowly stirring and mixing the emulsion for 10 minutes. Then the atmosphere in the system is completely replaced with nitrogen and the mixture in the flask is heated to 70° C. with stirring and emulsion-polymerization is continued as it is for 5 hours. A cationic resin particle dispersion solution containing polar resin particles having a volume average particle diameter of 60 nm, a glass transition point of −8° C. and a Mw of 120000 is thereby obtained. The acid value of colorant particle coating polar resin particles is 40 mg. Also, the content of water is adjusted such that the concentration of particles is 10% by weight.

Preparation of a Colorant Particle Dispersion Solution (1)

Cyan pigment (trade name: Copper Phthalocyanine C.I. Pigment Blue 15:3, manufactured by Dainichiseika Color & Chemicals Mfg. Co., Ltd.): 50 pass parts

Nonionic surfactant (trade name: Nonipol 400: manufactured by Kao Corporation): 5 parts

Ion Exchange water: 200 parts

The above components are mixed and dissolved, followed by dispersing by using a high-pressure impact type dying machine (trade name: Altimizer HJP30006, manufactured by Sugino machine Limited) for about one hour and the content of water is adjusted to obtain a colorant particle dispersion solution (1).

Preparation of a Colorant Particle Dispersion Solution (2)

Cyan pigment (trade name: Copper Phthalocyanine C.I. Pigment Blue 15:3, manufactured by Dainichiseika Color & Chemicals Mfg Co., Ltd): 50 pass parts

Nonionic surfactant (trade name: Nonipol 400: manufactured by Kao Corporation): 5 parts

Ion Exchange water: 200 parts

The above components are mixed and dissolved followed by dispersing by using a high-pressure intact type dispersing machine (trade name: Altimizer HTP30006, manufactured by Sugino machine Limited) for about 6 hours and the content of water is adjusted to obtain a colorant particle dispersion solution (2).

Preparation of a Colorant Particle Dispersion Solution (3)

Colorant particle coating polar resin particles are added dropwise carefully to the colorant particle dispersion solution (2) in an amount of 0.50 parts on solid basis and the mixture is again ta with a homogenizer (trade name: Ultraturrax, manufactured by IKE) for 5 minutes to stick polar resin particles to the colorant particles. The resulting colorant particles are heated to 60° C. and % stirred for 3 hours, followed by drying and then observed by SEM. As a result, it is found that the polar resin particles are stuck to the periphery of the colorants uniformly. The amount of water is adjusted to obtain a colorant particle dispersion solution (3).

Preparation of a Colorant Particle Dispersion Solution (4)

Cyan pigment (trade name: Copper Phthalocyanine C.I. Pigment Blue 15:3, manufactured by Dainichiseika Color & Chemicals Mfg Co., Ltd.): 50 pass parts

Nonionic surfactant (trade name: Nonipol 400: manufactured by Kao Corporation): 5 parts

Ion Exchange water: 200 parts

The above components are mixed and dissolved, followed by dispersing by using a high-pressure impact type dispersing machine (trade name: Altimizer HJP30006, manufactured by Sugino machine Limited) for about 10 minutes and the content of water is adjusted to obtain a colorant particle dispersion solution (4).

The characteristics of the colorant particle dispersion solutions are shown in Table 1.

TABLE 1
RESULTS OF EVALUATION OF CHARACTERISTICS
OF COLORANT PARTICLES

| | | | Concentration | Ratio of pigments |
|---|---|---|---|---|
| | d50 | <0.1 | of colorant | incorporated into |
| | (μm) | μm (%) | particles (%) | the toner (%) |
| Color pigment 1 | 105 | 42 | 10 | 98 |
| Color pigment 2 | 45 | 98 | 10 | 45 |
| Color pigment 3 | 65 | 88 | 10 | 95 |
| Color pigment 4 | 268 | 8 | 10 | 99 |

### Example 1

Production of a toner mother particle (1)

| | |
|---|---|
| Crystalline polyester resin dispersion solution (1) | 700 parts |
| Colorant dispersion solution (1) | 60 parts |
| Releasing agent dispersion solution (1) | 60 parts |
| Sodium sulfate | 3 parts |

A stainless round flask is charged with the above components, to which is then added 14 parts of an aqueous 10% nitric acid solution of polyaluminum chloride as a coagulant. Then, the mixture is dispersed using a homogenizer (trade name: Ultraturrax T50, manufactured by IKA) and then heated to 58° C. in a heating oil bath. The volume average particle diameter of the obtained coagulated particles is 5.5 μm.

This coagulated particle dispersion is kept at 58° C. for 30 minutes and then 120 parts of the resin particle dispersion solution (1) is gradually added in the coagulated particle dispersion solution. The temperature of the heating oil bath is raised to keep the dispersion solution at 60° C. for one hour. The volume average particle diameter of the obtained stuck particles is 5.8 μm, To this dispersion solution is added an aqueous 1N sodium hydroxide solution to adjust the solution to pH 7 and then the din solution is heated to 80° C. with stirring continuously, at which temperature the dispersion solution is kept for 3 hours. Thereafter, the solution is cooled to 20° C. at a rate of 20° C./min, then subjected to filtration, washed with ion exchange water and dried by a vacuum dryer to obtain coagulated particles The volume average particle diameter (D50%) of the united particles is 5.7 μm

### Example 2

Production of a toner mother particle (2)

| | |
|---|---|
| Crystalline polyester resin dispersion solution (2) | 700 parts |
| Colorant dispersion solution (1) | 30 parts |
| Colorant dispersion solution (2) | 30 parts |
| Releasing agent dispersion solution (1) | 60 parts |
| Sodium sulfate | 3 parts |

United particles having a volume average particle diameter (D50%) of 6.5 un are obtained in the same manner as in Example 1 except that the above dispersion solutions are used as the raw material.

### Example 3

Production of a toner mother particle (3)

| | |
|---|---|
| Crystalline polyester resin dispersion solution (2) | 700 parts |
| Colorant dispersion solution (1) | 30 parts |
| Colorant dispersion solution (3) | 30 parts |
| Releasing agent dispersion solution (1) | 60 parts |
| Sodium sulfate | 3 parts |

United particles having a volume average particle diameter (D50%) of 7.2 μm are obtained in the same manner as in Example 1 except that the above dispersion solutions are used as the raw material.

### Comparative Example 1

Production of a toner mother particle (4)

| | |
|---|---|
| Crystalline polyester resin dispersion solution (3) | 840 parts |
| Colorant dispersion solution (3) | 100 parts |
| Releasing agent dispersion solution (1) | 60 parts |
| Sodium sulfate | 3 parts |

A stainless round flask is charged with de above components, to which is then added 60 parts of an aqueous 10% nitric acid solution of polyaluminum chloride as a coagulant. Then, the mixture is dispersed using a homogenizer (trade name: Ultraturrax, manufactured by IKA) and then heated to 60° C. in a heating oil bath. This coagulated particle dispersion solution is heated to 80° C. by raising the Nature of the heating oil bath and kept in this condition for 3 hours. Thereafter, the solution is cooled to 20° C. at a rate of 20° C./min, then subjected to filtration, washed with ion exchange water and dried by a vacuum dyer to obtain coagulated particles. The volume average particle diameter (D50%) of the united particles is 5.9 μm.

### Comparative Example 2

Production of a toner mother particle (5)

| | |
|---|---|
| Crystalline polyester resin dispersion solution (4) | 920 parts |
| Colorant dispersion solution (1) | 20 parts |
| Releasing agent dispersion solution (1) | 60 parts |
| Cationic surfactant (trade name: Sanisol B50, | 1.5 parts |
| manufactured by Kao Corporation) | |

A stainless round flask is charged with the above components, to which is then added 8 parts of an aqueous 10% nitric acid solution of polyaluminum chloride as a coagulant Then, the mixture is dispersed using a homogenizer (trade name: Ultraturrax T50, manufactured by IKA) and then heated to 63° C. in a hooting oil bath This coagulated particle dispersion solution is heated to 80° C. by raising the temperature of the heating oil bath and kept in this condition for 5 hours. Thereafter, the solution is cooled to 20° C. at a rate of 20° C./min, then subjected to filtration, washed with ion exchange water and dried by a vacuum dryer to obtain coagulated particles. The volume average particle diameter (D50%) of the united particles is 7.4 μm.

### Comparative Example 3

Production of a toner mother particle (6)

| | |
|---|---|
| Crystalline polyester resin dispersion solution (4) | 790 parts |
| Colorant dispersion solution (3) | 150 parts |
| Releasing agent dispersion solution (1) | 60 parts |
| Cationic surfactant (trade name: Sanisol B50, | 1.5 parts |
| manufactured by Kao Corporation) | |

A stainless round flask is charged with the above components, to which is then added 12 parts of an aqueous 10% nitric acid solution of polyaluminum chloride as a coagulant. Then, the mixture is dispersed using a homogenizer (trade name: Ultraturrax T50, manufactured by IKA) and then heated to 60° C. in a heating oil bath. This coagulated particle dispersion solution is heated to 80° C. by raising the temperature of the heating oil bath and kept in this condition for 2 hour. Thereafter, the solution is cooled to 20° C. at a rate of 20° C./min, then subjected to filtration, washed with ion exchange water and dried by a vacuum dryer to obtain coagulated particles. The volume average particle diameter (D50%) of the united particles is 6.2 μm.

### Comparative Example 4

Production of a toner mother particle (7)

| | |
|---|---|
| Crystalline polyester resin dispersion solution (1) | 900 parts |
| Colorant dispersion solution (4) | 40 parts |
| Releasing agent dispersion solution (1) | 60 parts |
| Sodium chloride | 4 parts |

A stainless round flask is charged with the above components, to which is then added 50 parts of an aqueous 10% solution of calcium chloride as a coagulant. Then the mixture is dispersed using a homogenize (trade name: Ultraturrax T50, manufactured by IKA) and then heated to 60° C. in a heating oil bath. This coagulated pile dispersion is heated to 80° C. by raising the temperature of the heating oil bath and kept in this condition for 2 hour Thereafter, the solution is cooled to 20° C. at a rate of 20° C./min, then subjected to filtration, washed with ion exchange water and dried by a vacuum dryer to obtain coagulated particles, The volume average particle diameter (D50%) of the united particles is 8.5 μm.

<Evaluation of Various Characteristics of the Toner>

(Production a carrier)

| | |
|---|---|
| Ferrite particles (volume average particle diameter: 50 μm) | 100 parts |
| Toluene | 14 parts |
| Styrene-methylmethacrylate copolymer (component | 2 parts |
| ratio: 90/10, Mw = 80000) | |
| Carbon black (trade name: R330, manufactured by Cabot) | 0.2 parts |

First, the above components except for the ferrite particles are stud using a stirrer to prepare a coating dispersion solution. Next, this coating solution and the ferrites particles are placed in a vacuum deaeration type kneader and stored at 60° C. for 30 minutes. Then, the solution is deaerated under heating and reduced pressure to dry the particles to obtain a carrier.

(Production of a Developer)

Commercially available fumed silica (trade name: RX50) is added as an external additive to each of the toner mother particles (1) to (7) in an amount of 1.2 parts based on 100 parts of the toner and these components are mixed with each other by using a Henshel mixer to obtain electrostatic image developing toners (1) to (7).

Next, 5 parts of each of then toners is mixed with 100 parts of the above carrier to prepare two-component developers (1) to (7).

(Measurement of Loss Elastic Modulus)

The storing elastic modulus and the loss elastic modulus are fund from the dynamic viscoelasticity measured by a sinusoidal wave vibration method. The dynamic viscoelasticity is measured using a measuring device (trade name: ARES, manufactured by Rheometric Scientific Company)

First, the toner is formed into a tablet and it is then set to a parallel plate 25 mm in diameter. After normal force is set to 0, the plate is vibrated sinusoidally at an oscillation frequency of 6.28 rad/sec and the amount of strain is varied between 0.01% and 1.0% at 50° C. to confirm that the stress in linear relation to the amount of strain. The same tests are made at 100° C., 150° C. and 180° C. to confirm that the stress is in linear relation to the amount of strain.

The dynamic viscoelasticity is measured as follows. Specifically, the toner is formed into a tablet and it is then set to a parallel plate 25 mm in diameter. After normal force is set to 0, the plate is vibrated sinusoidally at an oscillation frequency of 6.28 rad/sec. The measurement is started at 50° C. and continued until the temperature is 180° C. The interval of measurement time is designed to be 30 seconds and temperature rise rate is designed to be 1° C./min. Also, during measurement, the amount of strain is kept in a range from 0.01% to 1.0% at each measuring temperature and so adjusted appropriately as to obtain fairly measured values to find the loss elastic modulus and the tangential loss from these measured results.

(Evaluation of the Amount of a Pigment)

The crystalline polyester resin dispersion solution (1) is mixed with the colorant dispersion solution (1) and water is vaporized in a dryer to produce a calibration powder. The ratio of the crystalline polyester resin dispersion solution to the colorant dispersion solution is adjusted such that the amount of the colorant in the calibration powder is 1%, 3%, 5%, 8%, 10%, 15% or 20%. The calibration powder is measured using fluorescent X-rays to make the calibration curves of the peak intensities of the colorant and fluorescent X-ry Cu, thereby finding the amount of the pigment in the toner.

The amount of each of the color pigments 1 to 4 to be independently incorporated into the toner is found based on the amount of a pigment to be incorporated in Example 1/Comparative Example 2/Comparative Examples 1/Comparative Example 4. The amount of particle pigment 0.1 μm or less μm size in the toner is found from the amount of the pigment to be incorporated into the toner and the ratio of les 0.1 μm or less in size in the pigment dispersion solution.

With rat to Example 2/Example 3 (pigment combined system), the ratio of the toner to be incorporated to the feed amount is calculated to find the amount of particle pigment 0.1 μm or less in size based on the ratio of the combined pigment to be fed.

The results of evaluation of the loss elastic modulus of the electrostatic image developing toner and the amount of the colorant are shown in Table 2.

TABLE 2
RESULTS OF EVALUATION OF CHARACTERISTICS OF ELECTROSTATIC IMAGE
DEVELOPING TONER

| | | | | | | | Amount of | <0.1 μm |
|---|---|---|---|---|---|---|---|---|
| | | | | | | | the colorant | Ratio |
| | Loss Elastic | Loss Elastic | Loss Elastic | Loss Elastic | Tangential | Tangential | to be | of the |
| | Modulus | Modulus | Modulus | Modulus | Loss | Loss | incorporated | colorant |
| | (Pa@60° C.) | (Pa@70° C.) | (Pa@100° C.) | (Pa@140° C.) | (@100° C.) | (@140° C.) | (%) | (%) |
| Electrostatic Image | 7.4 × 10⁷ | 6.5 × 10⁵ | 25000 | 9800 | 1.5 | 2.1 | 5.9% | 2.5% |
| Developing Toner 1 | | | | | | | | |
| Electrostatic Image | 8.8 × 10⁷ | 1.8 × 10⁵ | 8800 | 5800 | 2.4 | 2.9 | 6.3% | 3.4% |
| Developing Toner 2 | | | | | | | | |
| Electrostatic Image | 8.3 × 10⁷ | 3.4 × 10⁵ | 10800 | 8200 | 2.1 | 2.5 | 7.7% | 5.0% |
| Developing Toner 3 | | | | | | | | |
| Electrostatic Image | 9.7 × 10⁷ | 9.1 × 10⁵ | 105000 | 51000 | 0.6 | 1.2 | 9.5% | 8.4% |
| Developing Toner 4 | | | | | | | | |
| Electrostatic Image | 4.0 × 10⁷ | 1.2 × 10⁵ | 4300 | 500 | 2.8 | 3.3 | 0.9% | 0.88% |
| Developing Toner 5 | | | | | | | | |
| Electrostatic Image | 3.2 × 10⁷ | 2.8 × 10⁵ | 17000 | 5050 | 0.8 | 1.0 | 14.3% | 12.54% |
| Developing Toner 6 | | | | | | | | |
| Electrostatic Image | 6.1 × 10⁷ | 3.8 × 10⁵ | 12000 | 6400 | 3.2 | 3.5 | 4.0% | 0.32% |
| Developing Toner 7 | | | | | | | | |

(Production of a Fixed Image)

Evaluation of fixing is made using a remodeled machine of Docu Centre Color 500 manufactured by Fuji Xerox Co., Ltd.

A 25 mm×25 mm solid image is put on a mirror coat platinum paper (106 g/m²) manufactured by Fuji Xerox Co., Ltd. such that the amount of the toner is 4.5 g/m² and fixed. The fixing temperature is raised step by step between 70° C. and 220° C. to obtain a fixed image.

(Evaluation of Offset)

The offset of the fixed image formed at a firing temperature of 70° C. to 220° C. is visually evaluated. In a low temperature range, the temperature at which no offset is caused is defined as the lowest fixing temperature and in a high temperature range, the temperature at which offset starts to generate is defined as offset generation temperature to evaluate.

As to a judgment of the low-temperature fixing characteristics, the cases where the lowest fixing temperature is 120° C. or more, 110 to 120° C., 100° C. to 110° C. and 100° C. or less are judged to be d, c, b and a respectively to evaluate.

(Evaluation of Gloss/Gloss Unevenness)

The gloss of the fixed image is measured using a device (trade name: micro-TRI-gloss 4520, manufactured by Gardner) according to JIS Z 8741-1997, 60° mirror surface gloss measuring method. The low-temperature fixing characteristics are evaluated according to the following standard: in a temperature range from 100° C. to 140° C., the cases where the glossiness (Gs(60°)) is 30% or less, 30 to 40%, 40 to 50% and 50% or more are defined as d, c, b and a respectively.

Also, five same samples arm prepared and the temperature at which the standard deviation among five points glossiness measured is 3 or more is defined as gloss unevenness generation temperature.

(Evaluation of High-Temperature Firing Characteristics)

Among the offset generation temperature and gloss unevenness generation temperature, lower generation temperature is defined as the allowable highest fixing temperature.

The allowable highest temperature is rated as follows: 180° C. or more: a, 170 to 180° C., b, 160 to 170° C. and 160° C. or less d.

The results of fixing are shown in Table 3.

TABLE 3
RESULTS OF EVALUATION OF CHARACTERISTICS OF ELECTROSTATIC
IMAGE DEVELOPING TONER

| | | Evaluation | Gloss | | | | | |
|---|---|---|---|---|---|---|---|---|
| | Fixable | of low- | unevenness | Offset | Allowable | | | |
| | lowest | temperature | generation | generation | highest | | | |
| | temperature | fixing | temperature | temperature | fixing | Gloss (%) | Gloss (%) | Evaluation |
| | (° C.) | characteristics | (° C.) | (° C.) | temperature | (@110° C.) | (@160° C.) | of gloss |
| Example 1 | 100 | a | 185 | 210° C. | a | 52 | 62 | a |
| Example 2 | 95 | a | 175 | 190° C. | b | 58 | 51 | a |
| Example 3 | 95 | a | 190 | 220° C. | a | 58 | 54 | a |
| Comparative | 105 | a | 200 | 240° C. | a | 12 | 28 | d |
| Example 1 | | | | | | | | |
| Comparative | 95 | a | 155 | 175° C. | d | 62 | 41 | b |
| Example 2 | | | | | | | | |
| Comparative | 95 | a | 190 | 205° C. | a | 24 | 38 | d |
| Example 3 | | | | | | | | |
| Comparative | 95 | a | 160 | 185° C. | d | 58 | 48 | b |
| Example 4 | | | | | | | | |

Examples 1 to 3 respectively have the interval in which the value of loss elastic modulus varies 100 times or more with a temperature range of 10° C. in the temperature interval between 60 and 95° C. and it is therefore possible to attain low-temperature fixing.

Also, Examples 1 to 3 have the characteristic that the loss elastic modules G″ is 5×10³ Pa or more and 5×10⁴ Pa or less and the tangential loss is 1.5 or more and 3.0 or less in a temperature range from 100° C. to 140° C. Therefore, the allowable highest temperature is high and also, high gross is maintained from a low-temperature range to a high-temperature range. This is inferred to be because a colorant 0.1 μm or less in size is contained in an amount of 1% or more and 7% or less in the toner.

On the other hand, Comparative Example 1 has a loss elastic modulus G″ of 5×10⁴ Pa or more in a temperature range from 100° C. to 140° C. and high gloss cannot be therefore attained. Also, Comparative Example 2 has a loss elastic modulus G″ of 5×10³ Pa or less in a temperature range from 100° C. to 140° C. Therefore, the allowable highest fixing temperature is low and image defects are caused with ease. Comparative Example 3 has a tangential loss of 1.5 or less in a temperature range from 100° C. to 140° C. and high gloss cannot be therefore attained. Comparative Example 4 has a tangential loss of 3.0 or more in a temperature range from 100° C. to 140° C. Therefore the allowable highest fixing temperature is low and image defects are caused with case.

According to the electrophotographic toner of the invention, as mentioned above, low temperature fixing, a wide fixing latitude and a high quality image having high gloss can be attained at the same time by controlling the loss elastic modulus of the crystalline resin and the amount of the colorant particle component.

What is claimed is:

1. An electrostatic image developing toner comprising a binder resin, a colorant and a releasing agent, the toner having a temperature interval in which a value of loss elastic modulus varies 100 times or more within a temperature range of 10° C. in a temperature interval between 60 and 95° C. under measuring conditions of an angular frequency of 6.28 rad/sec and a temperature rise rate of 1° C./min, wherein a loss elastic modulus G″ is 5×10³ Pa or more and 5×10⁴ Pa or less and tangential loss is 1.5 or more and 3.0 or less in a range from 100° C. to 140° C. under a measuring condition of a temperature change rate of 1° C./min.

2. The electrostatic image developing toner of claim 1, wherein the binder resin includes a crystalline resin.

3. The electrostatic image developing toner of claim 2, wherein an aliphatic monomer having a structural ratio of 80 mol % or more is contained as a component of the crystalline resin.

4. The electrostatic image developing toner of claim 2, wherein the binder resin includes a polyester resin.

5. The electrostatic image developing toner of claim 4, wherein a dicarboxylic acid having a sulfonic acid group is contained as an acid component of the polyester resin.

6. The electrostatic image developing toner of claim 4, wherein a dicarboxylic acid having a double bond is contained as an acid component of the polyester resin.

7. The electrostatic image developing toner of claim 1, wherein as the binder resin, a combination of a crystalline resin and an amorphous high-molecular resin is used, wherein the crystalline resin is contained in an amount of 50% by weight or more.

8. The electrostatic image developing toner of claim 1, wherein a ratio of the colorant having a volume average particle diameter of 0.1 μm or less is 7% by weight or less and 1% by weight or more with respect to the toner.

9. The electrostatic image developing toner of claim 1, wherein the colorant is coated with polar resin particles.

10. The electrostatic image developing toner of claim 9, wherein the polar resin particles have an acid value of 10 to 50 mg KOH/g and a volume average particle diameter of 100 nm or less.

11. The electrostatic image developing toner of claim 1, wherein a content of the colorant the toner is 1 to 20% by weight.

12. The electrostatic image developing toner of Claim 1, wherein a content amount of the releasing agent in the toner is 5 to 30% by weight.

13. The electrostatic image developing toner of claim 1, wherein a melting point of the releasing agent is 30° C. or more.

14. The electrostatic image developing toner of claim 1, wherein the releasing agent has a primary maximum peak at 60 to 120° C. when measured according to ASTM D3418-8.

15. The electrostatic image developing toner of claim 1, wherein a median diameter of particles of the releasing agent in the toner is 100 to 2000 nm when measured by a transmission type electron microscope (TEM).

16. A electrostatic image developing developer comprising a toner and a carrier, the toner comprising a binder resin, a colorant and a releasing agent, and having a temperature interval in which a value of loss elastic modulus varies 100 times or more within a temperature range of 10° C. in a temperature interval between 60 and 95° C. under measuring conditions of an angular frequency of 6.28 rad/sec and a pa rise rate of 1° C./min, wherein a loss elastic modulus G″ is 5×10³ Pa or more and 5×10⁴ Pa or less and tangential loss is 1.5 or more an 3.0 or less in a temperature range from 100° C. to 140° C. under a measuring condition of a temperature change rate of 1° C./min.

17. The electrostatic image developing developer of claim 16, wherein a volume average particle of a core material of the carrier is 10 to 500 nm.

18. The electrostatic image developing developer of claim 16, wherein a volume specific resistant of the carrier is 10⁶ to 10¹⁴ Ωcm at 1000 V.

19. A method of producing an electrostatic image developing toner comprising:
producing a resin particle dispersion solution having resin particles having a volume average particle diameter of 1 μm or less, a colorant dispersion solution and a releasing agent dispersion solution;
mixing the resin particle dispersion solution, the colorant dispersion solution and the releasing agent dispersion solution to prepare a dispersion solution of coagulated particles containing the resin particles, a colorant and a releasing agent; and
uniting the coagulated particles by heating the dispersion solution of coagulated particles to temperature near or above a melting point of the resin particles to produce a toner having a temperature interval in which a value of loss elastic modulus varies 100 times or more within a temperature range of 10° C. in a temperature interval between 60 and 95° C. under measuring conditions of an angular frequency of 6.28 rad/sec and a temperature rise rate of 1° C./min, wherein a loss elastic modulus G″ is 5×10³ Pa or more and 5×10⁴ Pa or less and tangential loss is 1.5 or more and 3.0 or less in a temperature range from 100° C. to 140° C. a measuring condition of a temperature change rate of 1° C./min.

20. The method of producing an electrostatic image developing toner of claim 19, wherein a volume average particle diameter of the colorant particles of the colorant dispersion solution is 0.03 to 0.2 μm and a surface of the colorant is coated with a resin.
